(19) United States
(12) Patent Application Publication
(10) Pub. No.: US 2011/0041284 A1
(43) Pub. Date: Feb. 24, 2011

(54) RETRACTION MECHANISM

(75) Inventors: Motohiko Kimura, Kanagawa (JP); Yohei Shimizu, Kanagawa (JP)

Correspondence Address: KANESAKA BERNER AND PARTNERS LLP, 1700 DIAGONAL RD, SUITE 310, ALEXANDRIA, VA, 22314-2848, US

(73) Assignee: Nifco Inc., Kanagawa (JP)

(21) Appl. No.: 12/735,426

(22) PCT Filed: Jan. 16, 2009
(86) PCT No.: PCT/JP2009/050577

§ 371 Date: Jul. 15, 2010

(30) Foreign Application Priority Data
Jan. 17, 2008 (JP) 2008008001
Feb. 26, 2008 (JP) 2008044427

(51) Int. Cl. E05F 3/00; E05F 1/00

(52) U.S. Cl. 16/49; 16/71

(57) ABSTRACT

A retraction mechanism includes a striker provided in either a fixed body or a movable body which is movably supported by the fixed body; a catcher provided in the other body and engaging the striker at a predetermined moved position of the movable body to be capable of engaging and disengaging; and an urging device enabling to accumulate urging forces in a moving process of the movable body. The retraction mechanism retracts the movable body by the urging forces accumulated in the urging device in a state wherein the striker and the catcher are engaged. The retraction mechanism includes a guide device controlling a relative position between the striker and the catcher, and when the striker and the catcher change the relative position, the change thereof is absorbed by the guide device, so that the engagement becomes possible.

### FIELD OF TECHNOLOGY

This invention relates to a retraction mechanism for helping a moving operation of a movable body relative to a fixed body.

### BACKGROUND ART

FIGS. 17(a), 17(b) show a retraction mechanism disclosed in Patent Document 1; FIG. 17(a) is a pattern diagram of a drawer body which is not shown in the figures in a retracted position, and FIG. 17(b) is a pattern diagram of the drawer body in a withdrawal position. The reference numeral 50 represents a main body side wall, the reference numeral 55 represents a drive pin on a drawer body side, the reference numeral 60 represents an inclined portion disposed between the main body side wall and the drawer body, and the reference numeral 65 represents a spring. A guide track 51, which comprises a straight portion 51a extending in a front and back direction and an arched portion 51b, is provided on the main body side wall 50. The inclined portion 60 includes a slot 61 whose upper side is open and a slanted side wall 62 extending from a front side of the slot 61, and fits bolts 63, 63 in the guide track 51. The spring 65, in a state wherein one end is latched to the main body side wall and the other end is latched to the inclined portion 60, accumulates urging forces in the process wherein the drawer body is moved from the retracted position to the withdrawal position.

Then, when the drawer body is moved to a withdrawal direction, after the inclined portion 60 is moved along the straight portion 51a of the guide track, the inclined portion 60 is inclined forward at the arched portion 51b, and the drive pin 55 moves from the slot 61 to the slanted side wall 62. Thereby, the drawer body is latched to the withdrawal position against an urging force of the spring 65, and also pushed backward, so that after the drive pin 55 is returned to the slot 61 from the slanted wall portion 62, the drawer body is retracted by the urging forces accumulated in the spring 65.

In the above-mentioned conventional structure, for example, the drawer body is automatically slid nearly all the way from the withdrawal position to a retracted direction. However, for that portion, a strong pulling operational force is required from the retracted position to the withdrawal direction, so that the usability deteriorates. Also, as a lock mechanism latching the drawer body against the urging force of the spring 65, the drive pin 55 comes out of the slot 61 due to a front incline of the inclined portion 60 and engages the slanted side wall 62, so that an engaging force is weak, and there is a possibility that the latching is released due to a vibration and the like. Also, in the conventional structure, due to the change of the load capacity or storage load of the drawer body, deviations occur in a relative position of the inclined portion 60 and the drive pin 55, so that there was a possibility that a normal operation could not be carried out.

FIGS. 18(a), 18(b) show the structure disclosed in Patent Document 2, the reference numeral 21 represents a sliding door closer (retraction main body) attached to a frame upper side of a fixed body side opening portion, the reference numeral 3 represents an engagement pin (engaged means) provided on a sliding door side which is the movable body. This sliding door closer 21 comprises a case 22, a hook body (engaging means) 36, an urging spring 35, and the like. The case 22 has a short container shape, and forms an engagement groove portion 25 extending in a longitudinal direction from one end side, and a sliding groove portion 31 (comprising a straight groove portion 32 and a turning groove portion 33 which is folded back at one end side of the straight groove portion 32). The hook body 36 forms a holding depressed portion 46 which engages and disengages the engagement pin 3, and engagement projected portions 44, 45 which fit in the sliding groove portion 31. The urging spring 35 urges the hook body 36 to the other end side of the sliding groove portion 31 in the state wherein one end is latched to the hook body 36 and the other end is latched to a case 22 side, and accumulates the urging forces in the process that the sliding door is slid in an open direction from a closed position. The engagement pin 3 is attached to be capable of swaying along a sliding hole 8 of a plate 5 through an automatic return mechanism 4 relative to an upper end face of the sliding door, and to be capable of returning due to an urging force which is not shown in the figures.

In the above retraction mechanism, by a closing operation of the sliding door, as shown in FIG. 18(a), the engagement pin 3 is moved toward the retraction main body 21. Then, the engagement pin 3 is fitted in the engagement groove portion 25, and after sliding along this engagement groove portion 25, as shown in FIG. 18(b), the engagement pin 3 engages the holding depressed portion 46 on a hook body side, and is held. In this process, while the engagement projected portion 44 is guided by the turning groove portion 33 of the sliding groove portion 31, the hook body 36 rotates as a center of the engagement projected portion 45, and changes from a standby condition to a retracted condition, and then, fits in the straight groove portion 32. By this fitting, the hook body 36 is slid to a back end side of the case 22 by an urging force of the urging spring 35 in a state of engaging the engagement pin 3, so that the retraction is completed. Also, from this state, by an open operation of the sliding door, the engagement pin 3 is slid to a front end side of the case 22 with the hook body 36, and the urging forces are accumulated in the urging spring 35. Additionally, when the sliding door is opened, due to a return operation of the engagement pin 3 through the automatic return mechanism 4, the engagement projected portion 44 is moved from the straight groove portion 32 to the turning groove portion 33, and the hook body 36 is switched to the standby condition in FIG. 18(a).

The above retraction mechanism can be applied not only to the sliding door but also to the drawer body in a similar fashion. For example, when the sliding door or the drawer body is closed, the retraction mechanism is automatically switched up to the closed position due to an urging force of an urging means from the middle of the closing operation, so that an occurrence of an incomplete closed state of the sliding door can be reliably prevented. However; in this retraction mechanism, the urging spring is provided so that the hook body is rotated from the turning groove portion to the straight groove portion among the sliding groove portion. However, due to a position deviation, vibration, or the like, the engagement between the hook body and the engagement pin is disengaged just before the engagement projected portion on the hook body side moves to the turning groove portion, so that an improper operation could easily occur such that the hook body moves in a retracting direction by accumulated urging forces.

Patent Document 1: Japanese Examined Patent Publication No. H05-023763

Patent Document 2: Japanese Unexamined Patent Publication No. 2005-290769

### DISCLOSURE OF THE INVENTION

### Problems to be Solved by the Invention

The Object of the present invention is to provide a retraction mechanism which retracts the movable body from the middle by the urging force so as to be preferred for preventing rebound when the movable body is swiftly pushed in or for preventing the occurrence of an incomplete pushed-in state of the movable body. Especially, even if a relative position between engagement-related members changes, the retraction mechanism maintains an excellent operation by absorbing the change, and thereby, prevents the occurrence of the improper operation and improves reliability.

Also, as the retraction mechanism retracting the movable body from the middle by the urging force, the object of the present invention is to provide a retraction mechanism with high space efficiency by solving the improper operation especially as mentioned above.

### Means for Solving the Problems

In order to achieve the above-mentioned purposes, in a first aspect of the present invention, a retraction mechanism is provided by comprising a striker provided in either a fixed body or a movable body which is movably supported by the fixed body; a catcher provided in the other body and engaging the above-mentioned striker at a predetermined moved position of the above-mentioned movable body to be capable of engaging and disengaging; and an urging means enabling to accumulate urging forces in a moving process of the above-mentioned movable body. In the retraction mechanism which retracts the above-mentioned movable body by the urging forces accumulated in the above-mentioned urging means in a state wherein the above-mentioned striker and the above-mentioned catcher are engaged, the retraction mechanism includes a guide means controlling a relative position between the above-mentioned striker and the above-mentioned catcher, and when the above-mentioned striker and the above-mentioned catcher change the above-mentioned relative position, the change thereof is absorbed by the above-mentioned guide means, so that the engagement becomes possible.

In the first aspect of the present invention, the fixed body includes a storage main body for a drawer body, a frame main body for a sliding door, and the like. The movable body is the drawer body, the sliding door, and the like provided that the movable body has a relationship of reciprocating relative to the fixed body. The striker and the catcher are provided corresponding to the fixed body and the movable body, and engaged in the predetermined moved position (for example, if the movable body is the drawer body, it is in the middle wherein the drawer body is pushed in) of the movable body relative to the fixed body provided that the striker and the catcher have a relationship of enabling to retract the movable body by the urging forces accumulated in the urging means. As a concrete example, in a structure of Patent Document 1, a drive pin corresponds to the catcher, and an inclined portion corresponds to the striker.

In the first aspect of the present invention, for example, if the movable body is the drawer body, even if the relative position between the striker and the catcher is displaced or changed due to a change of an article load stored in the drawer body, and the like, the striker and the catcher are modified in a regular position due to a change absorption function of the guide means, so that the engagement becomes possible. Thereby, as a retraction mechanism, an operation defect caused by a relative position deviation can be reliably prevented so that quality and reliability can be improved.

In the first aspect of the present invention, the present invention is preferred to be embodied as follows.

(1) The present invention is structured such that the above-mentioned striker is disposed in a case with the above-mentioned urging means, and also that the above-mentioned catcher is supported by a holding member.

In this case, since the striker is unitized by being disposed in the case with the urging means, and the catcher is unitized by being supported by the holding member, both excel in handling characteristics, attaching characteristics to the fixed body or the movable body, and the like.

(2) The present invention is structured such that the above-mentioned catcher is supported relative to the above-mentioned holding member to be capable of moving only for a predetermined dimension.

In this case, since the catcher is supported relative to the holding member to be capable of moving only for the predetermined dimension, the catcher can change the position within the allowed moving range, and adjust in the most appropriate position relative to the striker.

(3) The present invention is structured such that the above-mentioned striker is attached to the above-mentioned fixed body through the above-mentioned case to be capable of moving only for the predetermined dimension.

In this case, since the striker is attached to the fixed body through the case to be capable of moving only for the predetermined dimension, the striker can change the position within the allowed moving range, and adjust in the most appropriate position relative to the catcher.

(4) The present invention is structured such that the above-mentioned guide means includes a guide groove provided in the above-mentioned case side and forming a groove doorway portion wider than the other groove portions, and a projection provided in the above-mentioned catcher side and sliding the above-mentioned guide groove.

In this case, since the catcher is slid in the state of fitting the projection into the guide groove of the case additionally provided on a fixed body side, a stable engagement with the striker can be maintained. Also, since the projection is received at the wide groove doorway portion among the guide grooves and moved to the narrow groove portion, even if a position of a groove width direction (i.e., a top-to-bottom position) between the catcher and the striker has changed, the position can be efficiently modified.

Also, in a second aspect of the present invention, the retraction mechanism is provided by comprising a retraction main body including an engaging means attached to either the fixed body or the movable body which is movably disposed in the fixed body; and an engaged means attached to the other body and engaged with/disengaged from the above-mentioned engaging means at a predetermined moved position of the above-mentioned movable body. In the retraction mechanism wherein the above-mentioned movable body enables to move by an urging force in an engagement state between the above-mentioned engaging means and engaged means, the retraction mechanism comprises the following (a) to (c).

(a) The above-mentioned retraction main body includes a case, an arm movably stored in the above-mentioned case and including the above-mentioned engaging means, and an urging means urging the above-mentioned arm in a retracting direction;

(b) The above-mentioned case includes a first movement portion for moving a relative position of the arm in a state wherein one end side of the above-mentioned arm is fitted, a guide groove flexed to the lower side from the first movement portion and comprising a standby holding portion for enabling to hold the urging force of the above-mentioned urging means, and a second movement portion allowing the turning and moving of the arm in the state wherein the other end side of the above-mentioned arm is fitted; and

(c) Due to the engagement between the above-mentioned engaging means and engaged means, one end side of the above-mentioned arm is released from the latching of the above-mentioned standby holding portion, and the arm is moved along the above-mentioned first movement portion by the urging force of the above-mentioned urging means. Also, when the arm is moved in an opposite direction, the urging forces are accumulated in the above-mentioned urging means by maintaining the engagement between the above-mentioned engaging means and engaged means, and one end side reaches the above-mentioned standby holding portion from the above-mentioned first movement portion.

In the second aspect of the present invention, the fixed body includes the storage main body for the drawer body, the frame main body for the sliding door, and the like. The movable body is the drawer body, the sliding door, and the like provided that the movable body has a relationship of reciprocating relative to the fixed body. The engaging means and the engaged means are attached corresponding to the fixed body and the movable body, and engage in the predetermined moved position (for example, if the movable body is the drawer body, it is in the middle wherein the drawer body is pushed in) of the movable body relative to the fixed body provided that the engaging means and the engaged means have the relationship of enabling to retract the movable body by the urging forces accumulated in the urging means.

In the second aspect of the present invention, the case includes the guide groove comprising the first movement portion for allowing the arm to move in the state wherein one end side of the arm is fitted, and the standby holding portion, and also the second movement portion allowing the arm to turn in the state wherein the other end side of the arm is fitted, or allowing the arm to move. Then, in this operation, as shown in the embodiment, in the engagement state between the engaging means and the engaged means, one end side of the arm enters into the flexed standby holding portion from the first movement portion, so that the arm is latched. A switch to this latched state can be reliably possible only by making an urging direction of the urging means relative to the arm downward in order for the arm to turn as a supporting point of the other end side of the arm which is fitted in the second movement portion, and to move one end side to the standby holding portion side. Therefore, in this retraction mechanism, compared to Patent Document 2, an urging-force accumulation state can be stably maintained, so that the occurrence of an improper operation can be prevented.

In the second aspect of the present invention, the present invention is preferred to be embodied as follows.

(1) The above-mentioned engaging means and engaged means comprise an axial portion and a bearing portion which are engaged and disengaged with each other, or a bearing portion and an axial portion which are engaged and disengaged with each other.

In this case, since the engaging means and the engaged means comprise the axial portion or the bearing portion which is engaged and disengaged with each other, the implementation becomes easier.

(2) The above-mentioned urging means is set such that the urging direction is located below a line connecting one end of the above-mentioned arm and the other end.

In this case, since the urging direction of the urging means is located below the line connecting both ends of the arm, one end side of the arm is reliably moved by the standby holding portion.

(3) The above-mentioned second movement portion is a slider slidably provided relative to the above-mentioned case.

In this case, since the second movement portion is the slider slidably provided relative to the case, the other end side of the arm is allowed to move in a stable state, and also by using the slider as shown in the embodiment, a rotary damper or a piston-type damper can be easily provided additionally.

(4) The above-mentioned second movement portion is a groove or a long hole provided in the above-mentioned case and extending in a moving direction of the above-mentioned arm.

In this case, since the second movement portion is the groove or the long hole provided in the case, the simplification is possible.

(5) The above-mentioned second movement portion is a link member rotatably attached as a supporting point of an attachment portion to the above-mentioned case.

In this case, the second movement portion is the link member rotatable as the supporting point of the attachment portion relative to the case, and an expansion as described in, for example, the following (7), can be possible.

(6) The second movement portion is provided in the above-mentioned case and includes a damping means damping a movement speed of the above-mentioned arm.

In this case, since the movement speed of the arm is damped by the damping means, when the movable body is retracted by the urging force, the movable body is allowed to gently move. Thereby, rebound of the movable body can be prevented, and an upscale feeling can be provided.

(7) The above-mentioned damping means is the piston-type damper including a cylinder and a rod. The damper is abutted against or connected to the above-mentioned rod, and also dampens through a connecting member connected between both ends of the above-mentioned link member.

In this case, the damping means can damp by controlling a stroke of the rod constituting the piston-type damper.

### BRIEF DESCRIPTION OF THE DRAWINGS

FIG. 1 is a schematic perspective view showing a relationship between a striker assembly body (retraction main body) and a catcher assembly body (engaged means) comprising a retraction mechanism of a first embodiment and a second embodiment of the present invention.

FIG. 2 is a schematic exploded view showing structure members of the above-mentioned striker assembly body (retraction main body).

FIGS. 3(a) to 3(c) show the above-mentioned striker assembly body (retraction main body) in an urging-force accumulation state, wherein FIG. 3(a) is a top view, FIG. 3(b) is a front view, and FIG. 3(c) is a rear view.

FIGS. 4(a) to 4(c) show the above-mentioned striker assembly body (retraction main body) in an urging-force release state, wherein FIG. 4(a) is a top view, FIG. 4(b) is a front view, and FIG. 4(c) is a rear view.

FIGS. 5(a) to 5(e) show the above-mentioned catcher assembly body (engaged means), wherein FIG. 5(a) is a top view, FIG. 5(b) is a front view, FIG. 5(c) is a rear view, FIG. 5(d) is a right side view, and FIG. 5(e) is a left side view.

FIGS. 6(a), 6(b) show a placement example of the striker assembly body (retraction main body) and the catcher assembly body (engaged means), wherein FIG. 6(a) is a pattern diagram viewed from the top, and FIG. 6(b) is a pattern diagram in the state of FIG. 6(a) viewed from a side face.

FIGS. 7(a), 7(b) show a guide operation of the above-mentioned retraction mechanism, wherein FIG. 7(a) is a pattern diagram showing a relationship between the catcher assembly body (retraction main body) and the striker assembly body (engaged means), and FIG. 7(b) is a pattern diagram showing an operation of a guide means.

FIGS. 8(a), 8(b) show the retraction of the above-mentioned retraction mechanism, wherein FIG. 8(a) is a pattern diagram showing a state at the time of the engagement, and FIG. 8(b) is a pattern diagram showing the state at the time of the retraction.

FIGS. 9(a), 9(b) show an urging-force accumulation of the above-mentioned retraction mechanism, wherein FIG. 9(a) is a pattern diagram showing a state at the time of the completion of the urging-force accumulation, and FIG. 9(b) is a pattern diagram showing a state after an engagement release.

FIGS. 10(a), 10(b) are, drawings showing a modified example of the first embodiment corresponding to FIGS. 6(a), 6(b).

FIGS. 11(a) to 11(c) are drawings showing a first modified example of the second embodiment corresponding to FIGS. 3(a) to 3(c).

FIGS. 12(a) to 12(c) are drawings showing the first modified example of the second embodiment corresponding to FIGS. 4(a) to 4(c).

FIGS. 13(a), 13(b) are drawings showing a second modified example of the second embodiment corresponding to FIGS. 11(b), 12(b).

FIG. 14 is an exploded perspective view showing a structural example of the engaged means used for the above-mentioned second modified example.

FIGS. 15(a) to 15(d) show details of the engaged means used for the above-mentioned second modified example, wherein FIG. 15(a) is a front view, FIG. 15(b) is a rear view, FIG. 15(c) is a left side view, and FIG. 15(d) is a right side view.

FIGS. 16(a), 16(b) are drawings showing a third modified example of the second embodiment corresponding to FIGS. 3(c), 4(c).

FIGS. 17(a), 17(b) are reference views for explaining the retraction mechanism of Patent Document 1.

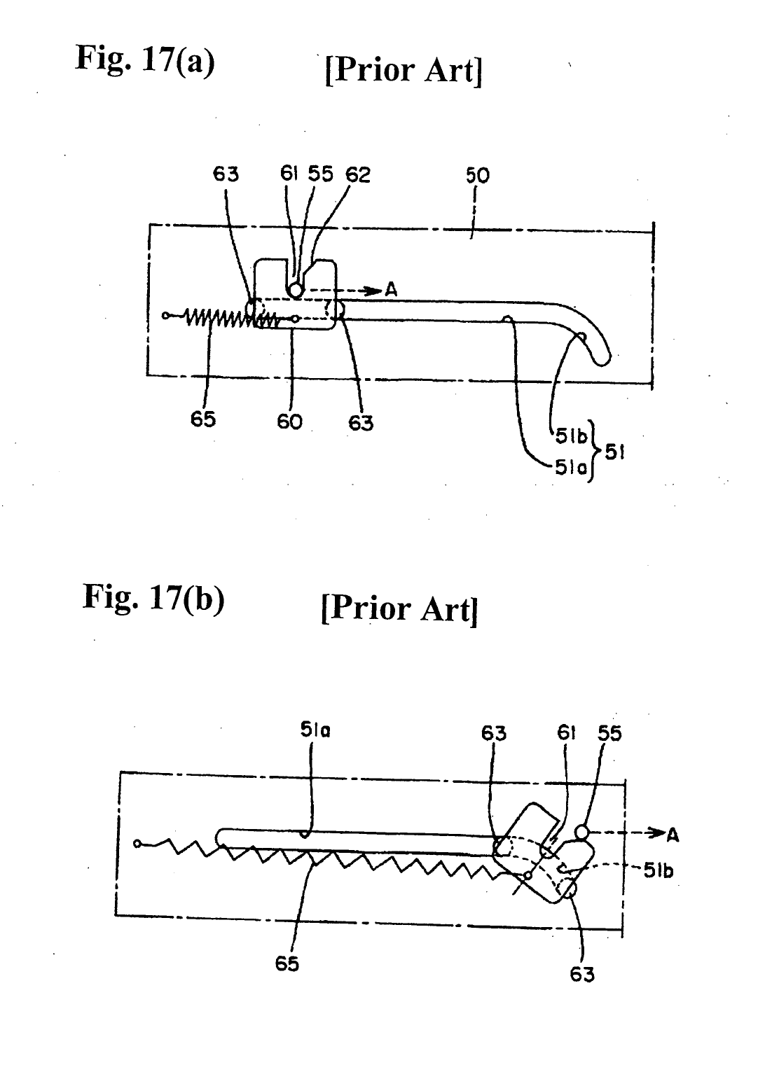

FIGS. 18(a), 18(b) are reference views for explaining the retraction mechanism of Patent Document 2.

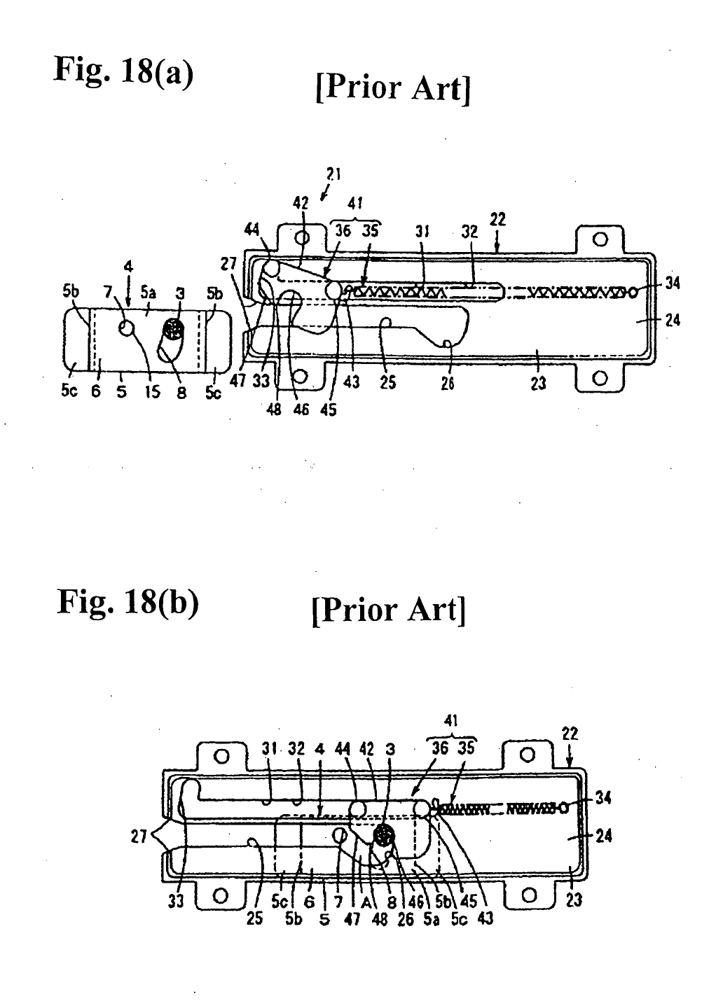

### BEST MODES OF CARRYING OUT THE INVENTION

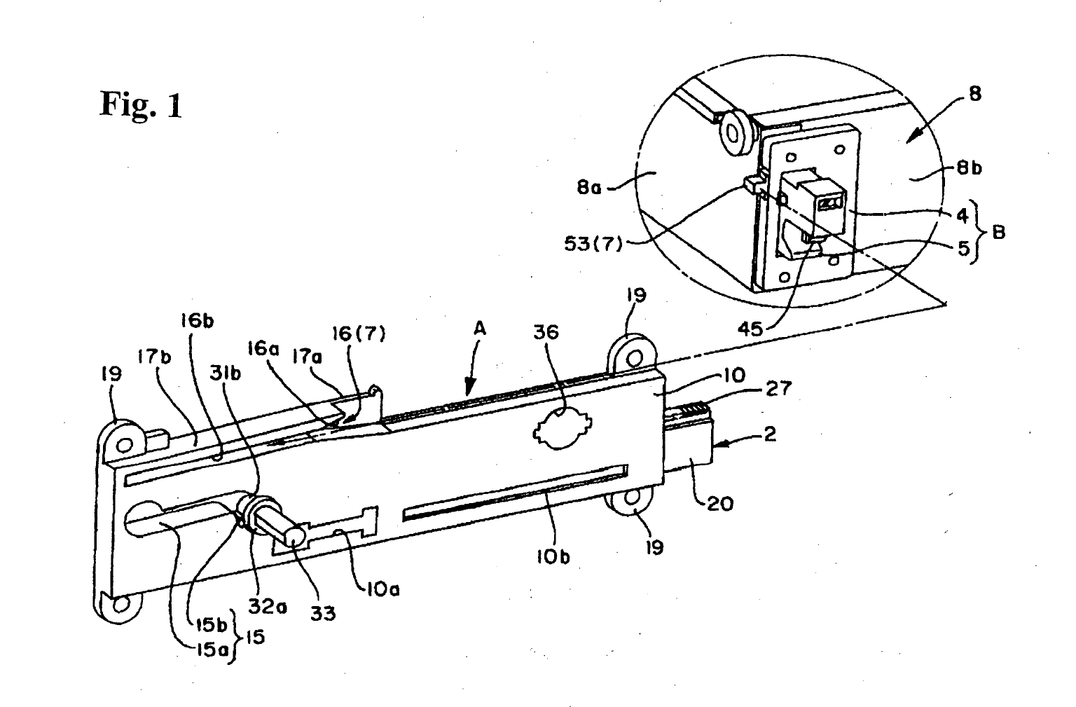

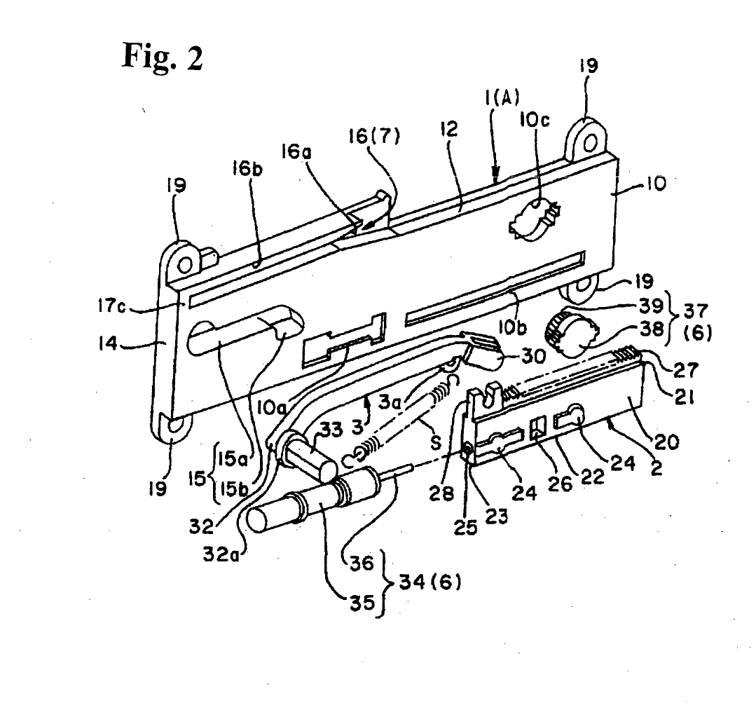

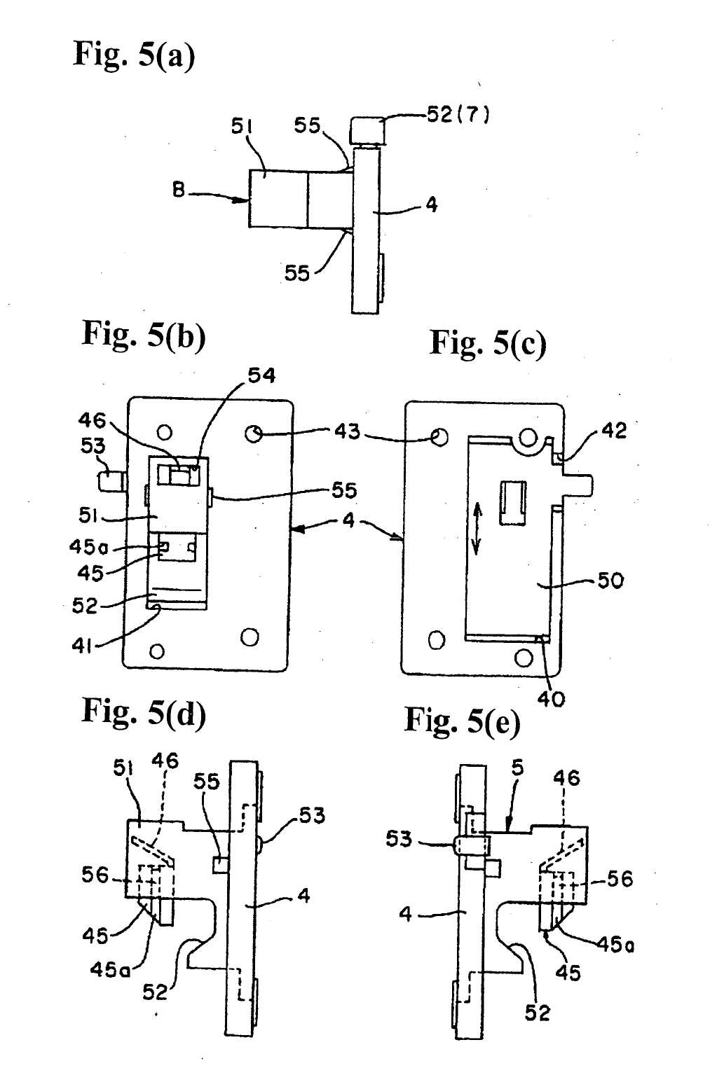

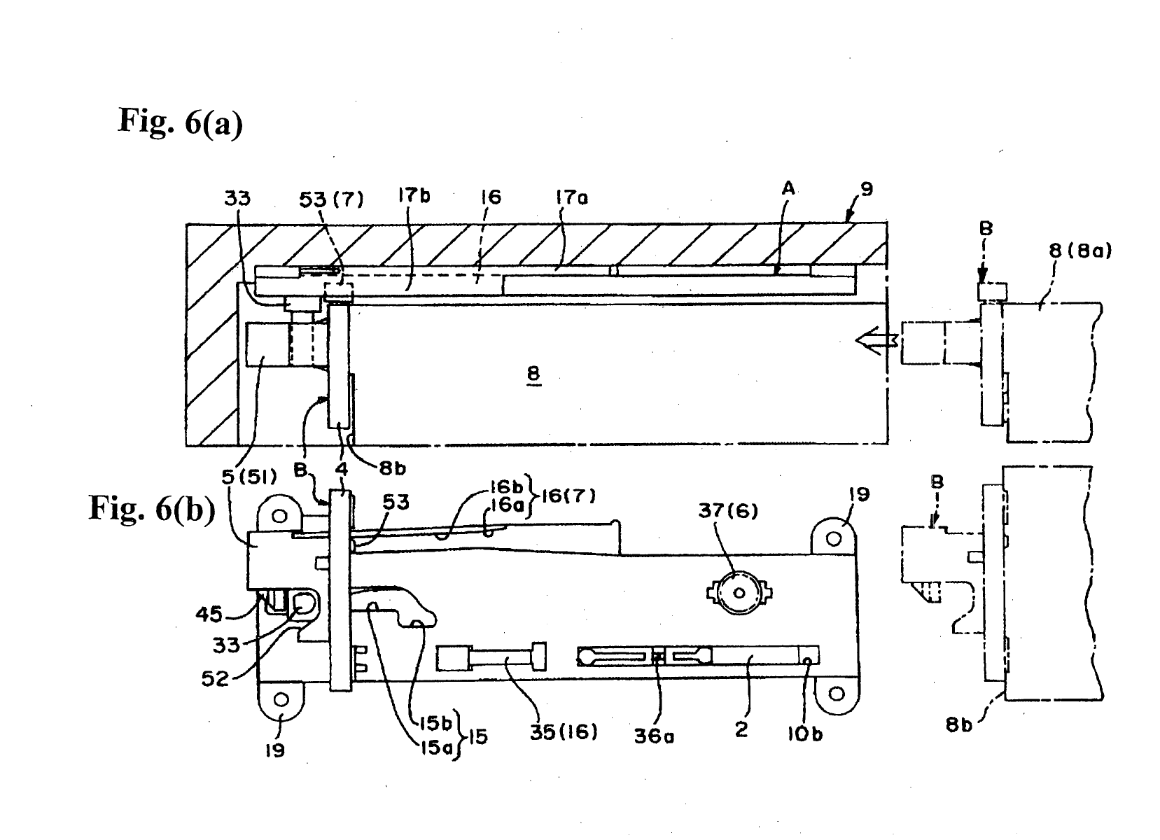

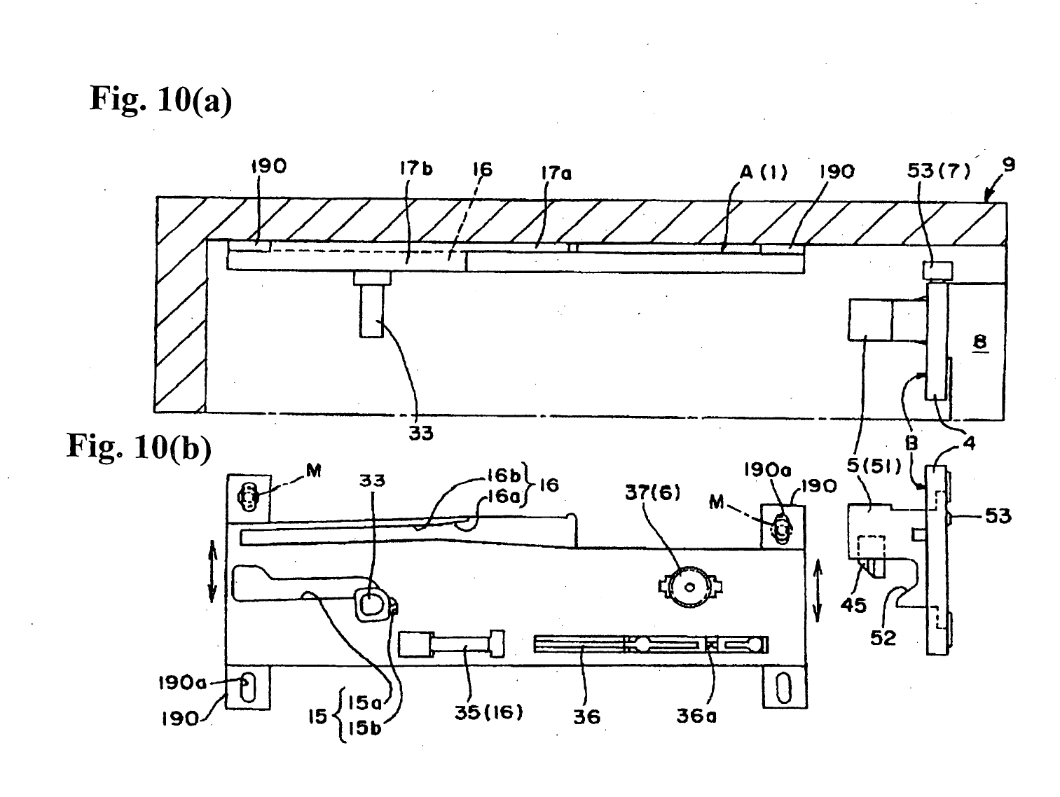

A first embodiment of the present invention will be explained with reference to the drawings. FIG. 1 shows a relationship between a striker assembly body and a catcher assembly body, FIGS. 2 to 4(c) show the structure and operation characteristics of the striker assembly body, FIGS. 5(a) to 5(e) show the structure and operation characteristics of the catcher assembly body, FIGS. 6(a) to 9(b) show usage examples, and FIGS. 10(a), 10(b) show the modified example of the first embodiment. Incidentally, in each figure, some portions are omitted for constructing the drawings. In the following explanation, mechanism characteristics, the striker assembly body, the catcher assembly body, the usage examples, operations, and the modified example are described in detail in that order.

(Mechanism characteristics) For example, in the case that the usage is for moving a drawer body 8 into and out of a storage main body 9, the retraction mechanism of the embodiment comprises a striker 33 constituting a striker assembly body A provided in either the storage main body 9 or the drawer body 8 movably supported by the storage main body 9; a catcher 5 constituting a catcher assembly body B provided in the other body and engaging the striker 33 at a predetermined moved position of the drawer body 8 to be capable of engaging and disengaging; and a coil spring S which is an urging means enabling to accumulate urging forces in a moving process of the drawer body 8. The retraction mechanism retracts the drawer body 8 by the urging forces accumulated in the coil spring S in the state wherein the striker 33 and the catcher 5 are engaged. The subject of the invention is to include a guide means 7 controlling a relative position of especially the striker 33 and the catcher 5, and to enable to engage the striker 33 and the catcher 5 when the above-mentioned relative position is changed due to a large or small movable load in the drawer body 8 and the like by absorbing the change by the guide means 7.

(Striker assembly body) As shown in FIGS. 1 to 4(c), this assembly body A comprises an approximately short-shaped case 1; a slider 2 slidably disposed in the case 1; an arm 3 connected to the slider 2; the above-mentioned coil spring S; and a damping means 6 damping the movement of the slider 2 and the arm 3. Among these, the damping means 6 is constituted by a piston-type damper 34 and a rotary damper 37. The piston-type damper 34 has a structure of including a cylinder 35 and a piston rod 36 gently coming in and out of the cylinder, and that the piston rod 36 gently drives relative to the cylinder 35. The rotary damper 37 has a structure including a case 38, an axis damped by an operating oil and the like inside the case, and a gear 39 mounted on the axis. However, the damping means 6 can be omitted, or only one of the dampers 34, 35 can be used, or conversely, the plural dampers 37 can be used.

The case 1 is long and thin in a front and back direction, the inner space is approximately divided by a front face 10, a rear face 11, upper and lower faces 12, 13, and one end face 14, and the other end face is open. A supporting groove 10a engaging and controlling the cylinder 35 of the piston-type damper, a damper attachment hole 10c, and a guide hole 15 fitted in a corresponding portion of the arm 3, are provided in the front face 10. The damper 37 is attached to the attachment hole 10c in a state of engaging and fixing the case 38. The guide hole 15 includes a horizontal hole 15a horizontally extending just from the front of one end face 14 and a latching hole 15b bent downward from the end portion of the horizontal hole. Guide holes 10b, 11b guiding the slider 2 are oppositely provided on the front face 10 and the rear face 11. In addition to the guide hole 11b, a depressed storage portion 11a; an approximately short-formed opening portion 11c wherein a portion opposing the guide hole 15 is lacked; and a spring retainer portion 18 projecting from a lower inner face of the opening portion 11c, are provided in the rear face 11. The damper 34 is attached to the storage portion 11a in a state of engaging and fixing the cylinder 35.

A guide groove 16 with a C-shaped cross-section, which extends toward one end face 14 side from approximately the middle, is provided on the upper face 12. This guide groove 16 is divided by a longitudinal wall 17a provided on the upper face 12; a horizontal wall 17b projecting from the longitudinal wall 17a and opposing the upper face 12; and a standing wall 17c located in one end face 14 side and connecting each end portion of the horizontal wall 17b and the upper face 12. Also, a groove doorway portion 16a is formed wider, i.e., with a large top-to-bottom space, than a groove portion 16b which is located on the back side of the groove doorway portion 16a. Additionally, in the groove doorway portion 16a, the opposed portions of the upper face 12 and the horizontal wall 17b have tapered faces wherein the top-to-bottom space becomes narrower as the opposed portions of the upper face 12 and the horizontal wall 17b come closer to the groove portion 16b. The reference numeral 19 represents attachment portions with holes projecting from the upper face 12, the lower face 13, and the horizontal wall 17b.

The whole slider 2 has a slender plate shape which is approximately divided by both side faces 20, upper and lower faces 21, 22, and opposed end faces 23. The slider 2 includes plural projected portions 24 respectively projecting from both side faces 20 and fitting in the guide holes 10b, 11b on the case side; a through-hole 25 extending from one end face 23 toward the other middle side and penetrating the above-mentioned piston rod 36; a latching small opening 26 opened on both side faces 20 and intersecting the end of the through-hole 25; a rack 27 located on the upper face 21 and continuously provided from one end face 23 up to just before the other end face; and an approximately U-shaped supporting portion 28 provided between the rack 27 and the end face 23.

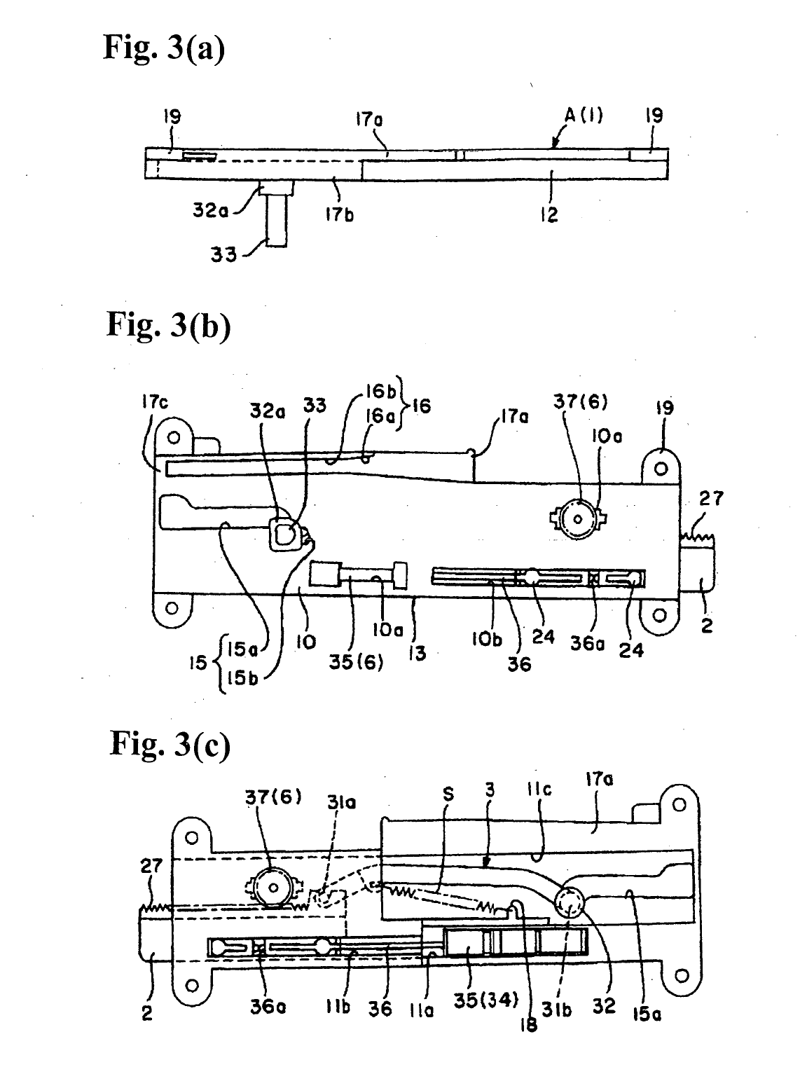

In the arm 3, one end portion 30 is pivotally supported at the supporting portion 28 on a slider side to be capable of freely turning, and at the other end portion 32, an axial portion 31b (see FIG. 3(c)) fitted in the guide hole 15 projects. Specifically, one end portion 30 is formed in an approximately C-shape, includes a connecting axis 31a provided between both piece portions of the C-shape, and is connected to the supporting portion 28 on the slider side in a state wherein the connecting axis 31a is fitted in the inside of the U-shape. The other end portion 32 forms the above-mentioned axial portion 31b projecting from a side face; a flange portion 32a provided in the end of the axial portion 31b and slightly larger than the guide hole 15 so as not to escape from the guide hole 15; and the striker 33 projecting from the outside face of the flange portion 32a, on the same axial line. Also, just before one end portion 30, a spring retainer portion 3a is projected downwardly.

The above slider 2, the arm 3, and the coil spring S are mounted on the case 1 by the following procedure. At first, the slider 2 is entered into the case from the opening of the other end face which opposes one end face 14 relative to the case 1. Also, the projected portions 24 on both sides are fitted in the guide holes 10b, 11b so as to horizontally slide along the guide holes. In this case, the piston rod 36 on a damper side placed inside the storage portion 11a is inserted into the through-hole 25 on the slider side, and a cap-shaped stopper 36a is placed in the end projecting from the small opening 26, so that the piston rod 36 is connected to the slider 2. Also, in the damper 37 placed in the attachment hole 10c, the gear 39 is engaged with the rack 27 on the slider side. Consequently, the slider 2 is slid while being damped by the piston-type damper 34 and the rotary damper 37.

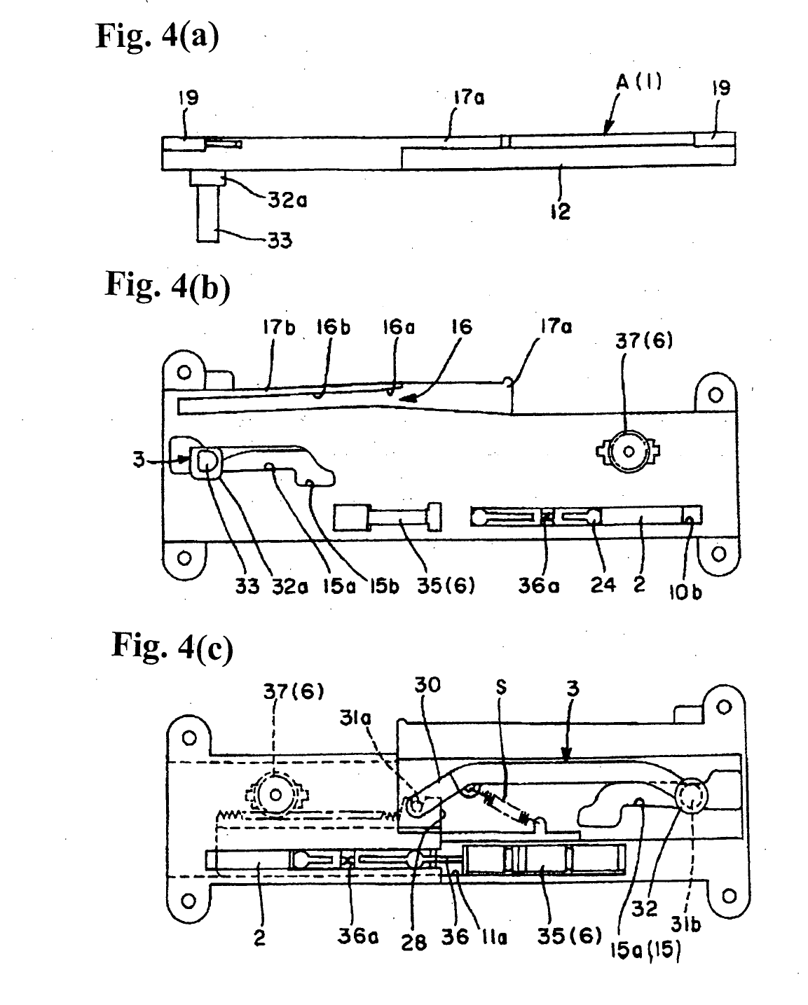

Also, as shown in FIG. 4(c), in the arm 3, the connecting axis 31a of one end portion 30 is fitted in the supporting portion 28 on the slider side, and mounted on the inside of the case 1 in a state wherein the axial portion 31b of the other end portion 32 is penetrated into the guide hole 15. At that time, the flange portion 32a with a large diameter is inserted into the guide hole 15 by using a slightly large relief hole provided in the end portion of the horizontal hole 15a, so that the other end portion 32 is disposed in the case 1 in a retaining state. In this state, the striker 33 horizontally projects from the guide hole 15. Next, in the coil spring S, one end is latched to the retainer portion 18 on the case side, and the other end is latched to the retainer portion 3a on an arm side. Thereby, the striker assembly body A is completed.

(Catcher assembly body) As shown in FIGS. 1 and 5(a) to 5(e), this assembly body B comprises an approximately plate-shaped holding member 4, and the catcher 5 supported by the holding member 4 to be capable of moving only for a predetermined top-to-bottom dimension. Among these, the holding member 4 includes a short-formed depressed portion 40 which is long from top to bottom and provided on a rear face side; a short-formed opening 41 whose two sides are penetrated except for the top-to-bottom portion and the right-to-left portion inside the depressed portion 40; a relief portion 42 whose upper one side portion inside the depressed portion 40 is devoid and which is communicated to the outside from the inside of the depressed portion 40; and attachment holes 43 provided in plural places.

The catcher 5 includes a plate portion 50 corresponding to the depressed portion 40; an upper holding portion 51 and a lower engaging portion 52 which are projected from a surface side of the plate portion 50 and disposed by projecting from the opening 41 to a front face side; and a claw member 45 mounted on the upper holding portion 51 to be movable up and down. The plate portion 50 forms a projection 53, which fits in the above-mentioned guide groove 16, on the upper side of one side face. When the plate portion 50 is disposed to be movable in an up-and-down direction inside the depressed portion 40, the projection 53 is also moved up and down in a state of projecting from the relief portion 42 to the outside. The upper holding portion 51 and the lower engaging portion 52 are retained through claws 55 provided on both outside faces of the upper holding portion 51 in a state of being projected from the opening 41 to the front face side of the plate portion 50 so as to be movable up and down. The lower engaging portion 52 is formed in a taper which is lowered as going down, and when the lower engaging portion 52 hits the striker 33 of the above-mentioned latched state, due to a forward movement of the catcher assembly body B, the lower engaging portion 52 allows the striker 33 to escape from the latching hole 15b to the horizontal hole 15a by the above-mentioned taper function.

On the other hand, the upper holding portion 51 is a hollow portion whose projecting end side is the lower portion and one portion 54 of an end face is open. Then, in the hollow portion, guide ribs 56 guiding the claw member 45 are oppositely provided on both inside faces. Specifically, as shown in FIGS. 5(b), 5(d), in the claw member 45, the end is formed in an inclined surface, and also includes longitudinal grooves 45a provided on both sides, and an elastic piece portion 46 projected from the upper side. Then, in the claw member 45, each longitudinal groove 45a is fitted in the corresponding guide rib 56, and the piece portion 46 is disposed in a state of abutting against the inner upper face of the above-mentioned hollow portion, so that usually, the claw member 45 is urged to a projecting state in FIGS. 5(b), 5(d) through the piece portion 46. If the claw member 45 receives upward stress, the claw member 45 escapes in a going-down direction against an elastic force of the piece portion 46 once, and then, when the stress disappears, the claw member 45 becomes a projecting state again.

(Usage example) FIGS. 6(a), 6(b) (and a portion shown in the upper right in FIG. 1) are an example wherein the above retraction mechanism is applied to the retraction of the drawer body 8. In this placement, the striker assembly body A is attached to the inside face of the storage main body 9, and also the catcher assembly body B is attached to a back end face 8b of the drawer body 8. In this case, the striker assembly body A is fixed by using the above-mentioned attachment portions 19 on the case side, screws, and the like. The catcher assembly body B is fixed by using the above-mentioned attachment holes 43, the screws, and the like. However, at that time, the projection 53 is positioned so as to project from a side face 8a of the drawer body 8 corresponding to the guide groove 16 of the striker assembly body A. Incidentally, as the other placement, the striker assembly body A can be attached to a drawer body 8 side, and corresponding to that, the catcher assembly body B can be attached to a storage main body 9 side. Also, the striker assembly body A and the catcher assembly body B can retract the movable body by using two pairs of movable bodies. However, in such a case, if the movable body is the drawer body 8, one side has a symmetrical shape relative to the above-mentioned embodiment.

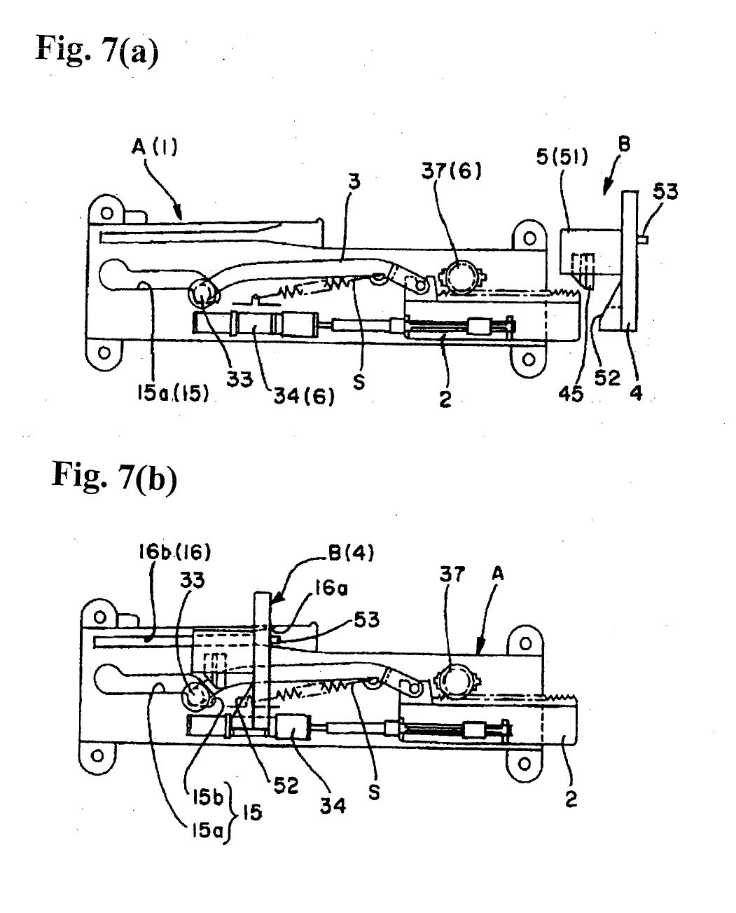

(Operations) Operations of the above retraction mechanism will be explained in detail with reference to FIGS. 3(a) to 3(c), 4(a) to 4(c), and 7(a) to 9(b). Incidentally, in FIGS. 7(a) to 9(b), main operations are shown on the assumption of the usage example of FIGS. 6(a), 6(b), and FIGS. 7(a) to 9(b) are simplified or schematized in order to demonstrate the relationship of each member.

(1) At first, the operations of the striker assembly body A are demonstrated. This assembly body A is switched between an urging-force accumulation state wherein the coil spring S accumulates the urging forces as shown in FIG. 3(c), and an urging-force release state wherein the coil spring S releases the urging forces as shown in FIG. 4(c). In this retraction mechanism, in the urging-force accumulation state, the coil spring S accumulates the urging forces up to the maximum through the sliding of the arm 3. In the arm 3, the axial portion 31b is latched to the latching hole 15b. In the damper 34, the piston rod 36 is largely extracted from the cylinder 35. Then, from this urging-force accumulation state, when the latching of the axial portion 31b is released from the latching hole 15b, and the axial portion 31b is allowed to escape to the horizontal hole 15a, the striker 33, the arm 3, and the slider 2 are integrally slid along the horizontal hole 15a by the urging force of the coil spring S. This latching release is carried out with the engagement of (the catcher 5 of) the catcher assembly body B with the striker 33 as mentioned hereinafter. When the latching is released, the catcher assembly body B is interlocked with the arm 3 and slid by maintaining the engagement state between the striker 33 and the catcher 5, i.e., the catcher assembly body B is automatically retracted while being damped by the above-mentioned each damper 34, 37. In this retraction mechanism, in the urging-force release state, the coil spring S releases the urging force through the sliding of the arm 3, or minimizes the urging force. The arm 3 disposes the axial portion 31b in an appropriate place of the horizontal hole 15a. The damper 34 is in a state wherein the piston rod 36 is sunk mostly in the cylinder 35.

(2) FIGS. 7(a), 7(b) show a change absorption operation which corrects a mutual positional relationship by the guide means 7 at a previous stage that the catcher assembly body B engages the striker assembly body A. As the usage example of the above-mentioned FIGS. 6(a), 6(b), for example, this is to solve a problem by the guide means 7, wherein the relative position between the catcher 5 of the catcher assembly body B and the striker 33 of the striker assembly body A changes due to the change of the load capacity or storage load in the drawer body 8, so that the catcher 5 and the striker 33 cannot be normally engaged with each other. Specifically, in this guide means 7, as shown in FIG. 7(b), when the catcher assembly body B is moved closer to the striker assembly body A, (A) the projection 53 on a catcher side is slid in a state of being fitted in the guide groove 16 of the case 1, so that the catcher 5 (the lower engagement portion 52 and the claw member 45) and the striker 33 are accurately positioned; (B) the projection 53 is received at the wide groove doorway portion 16a among the guide groove 16, and moved while being centered by the narrow groove portion 16b, so that even if a position of a groove width direction (i.e., the top-to-bottom position) between the catcher 5 (the lower engagement portion 52 and the claw member 45) and the striker 33 has changed, the position can be efficiently modified; and (C) the catcher 5 (the lower engagement portion 52 and the claw member 45) is supported relative to the holding member 4 to be movable only for a predetermined dimension, so that the catcher 5 changes the position within the allowed moving range and is adjusted in the most appropriate position relative to the striker 33. Due to those operations, the change of the above-mentioned relative position is efficiently and reliably absorbed, so that the improper operation is eliminated.

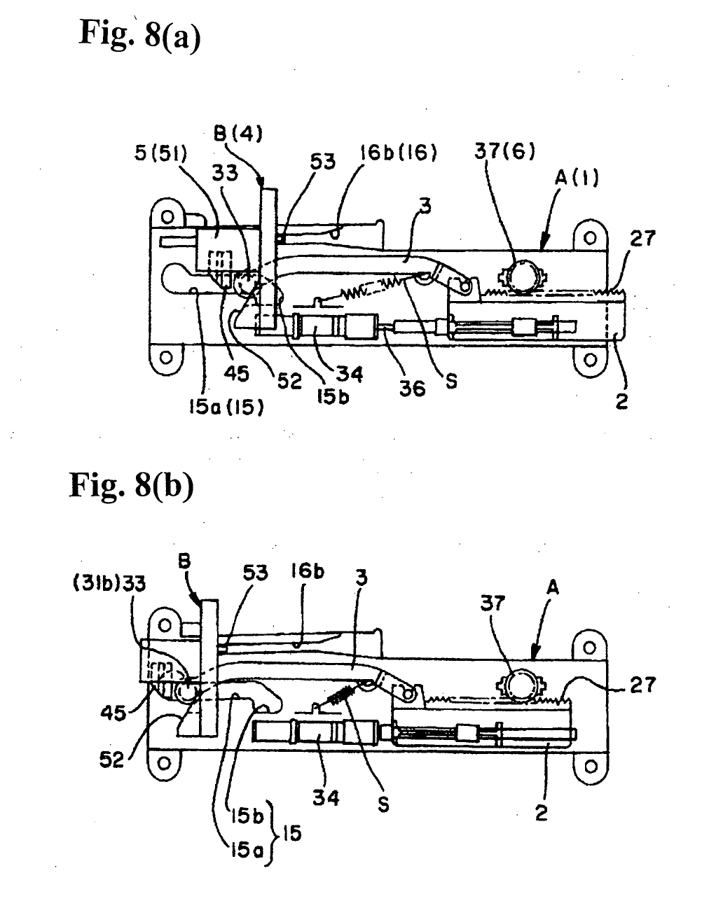

(3) FIGS. 8(a), 8(b) show a retracting operation of the movable body such as the drawer body and the like when the catcher assembly body B is engaged with the striker assembly body A, and retracted by the urging force. Specifically, in this retraction mechanism, as shown in FIG. 8(a), when the catcher assembly body B is moved closer to the striker assembly body A, at first, the claw member 45 of the catcher 5 moves upwardly against the urging of the above-mentioned piece portion 46, and passes through the striker 33, and at the same time, the striker 33 is pushed upwardly or in an obliquely upward direction by (the taper shape of) the lower engagement portion 52, so that the catcher assembly body B is allowed to escape from the latching hole 15b to the horizontal hole 15a, so that the latching is released. Due to this latching release, as shown in FIG. 8(b), while the catcher assembly body B maintains the engagement between the catcher 5 (the lower engagement portion 52 and the claw member 45) and the striker 33, the arm 3 and the slider 2 are slid by the urging force of the coil spring S, and the catcher assembly body B is retracted by being interlocked with the sliding. As the usage example of the above-mentioned FIGS. 6(a), 6(b), due to the urging forces accumulated in the coil spring S from the middle wherein the drawer body 8 is pushed in, the drawer body 8 is automatically retracted (while being damped by the damping means 6) up to the final pushed-in position, and thereby, rebound when the drawer body 8 is swiftly pushed in, can be prevented, and also an occurrence of an incomplete pushed-in state of the drawer body 8 can be prevented.

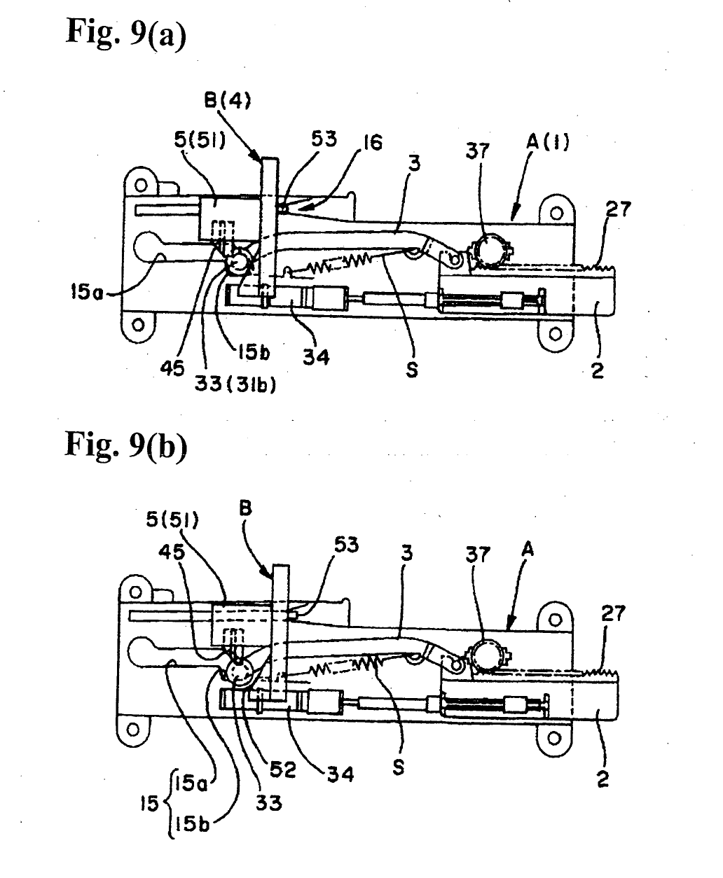

(4) FIGS. 9(a), 9(b) show the operation at the time that the movable body such as the above-mentioned drawer body 8 and the like is moved from a retracted state in FIG. 8(b) to a withdrawal direction again, and the above-mentioned engagement is released. Specifically, in this retraction mechanism, as shown in FIG. 9(a), in a process that the catcher assembly body B is moved in a direction away from the striker assembly body A, at first, in the state wherein the striker 33 is engaged with the catcher 5 (the lower engagement portion 52 and the claw member 45), when the catcher assembly body B comes to the top of the latching hole 15b which is one step lower from the horizontal hole 15a, the catcher assembly body B is pushed by the claw member 45, entered into the latching hole 15b, and latched. After that, as shown in FIG. 9(b), the catcher 5 (the lower engagement portion 52 and the claw member 45) releases the engagement with the striker 33, so that the catcher assembly body B is separately moved in an operation direction. Also, in this withdrawal mechanism, in the state wherein the striker 33 is engaged with the catcher 5 (the lower engagement portion 52 and the claw member 45), when the catcher assembly body B is moved up to the place in FIG. 9(a) from FIG. 8(b) by a withdrawal operation such as the drawer body 8 and the like, the striker 33, i.e., the arm, 3 and the slider 2 are also interlocked and moved in the same direction, so that the urging forces are accumulated in the coil spring S. This urging-force accumulation continues up to the time that the catcher 5 of the catcher assembly body B is disengaged from the striker 33.

(Modified example of the first embodiment) FIGS. 10(a), 10(b) show the modified example of the first embodiment. This modified example has a structure such that the striker 33 is attached to a fixed body such as the storage main body 9 and the like through the case 1 to be movable only for the predetermined dimension. In this explanation, the same symbols are assigned to the same members and the operationally same portions with those of the above-mentioned embodiment, and duplicated descriptions are omitted as much as possible. In this withdrawal mechanism, the attachment portions of the case constituting the striker assembly body A are modified relative to the above-mentioned embodiment. The attachment portions 190 are provided in plural portions of the case 1, and in the attachment portions 190, holes 190a, wherein stoppers M such as the screws and the like are inserted, are formed in a long hole whose top-to-bottom dimension is larger than the width dimension. Then, in this withdrawal mechanism, the striker assembly body A is attached by inserting the stoppers M into the top-to-bottom long holes 190a relative to the inside face of the storage main body 9, so that the striker 33 can move only for the dimension in proportion to the length of the hole 190a through the case 1. Thereby, as the above-mentioned guide means 7, even if the catcher 5 of the catcher assembly body B is simplified and integrally formed with the holding member 4, the striker 33 changes the position within the above-mentioned allowed moving range through the case 1 so as to enable to adjust in the most appropriate position relative to the catcher 5.

Next, the second embodiment of the present invention will be explained. Regarding the second embodiment, the striker assembly body A of the first embodiment is considered to be a retraction main body A, the catcher assembly body B of the first embodiment is considered to be an engaged means B, and the second embodiment will be explained by using FIGS. 1 to 9(b) which were referenced for the explanation of the first embodiment.

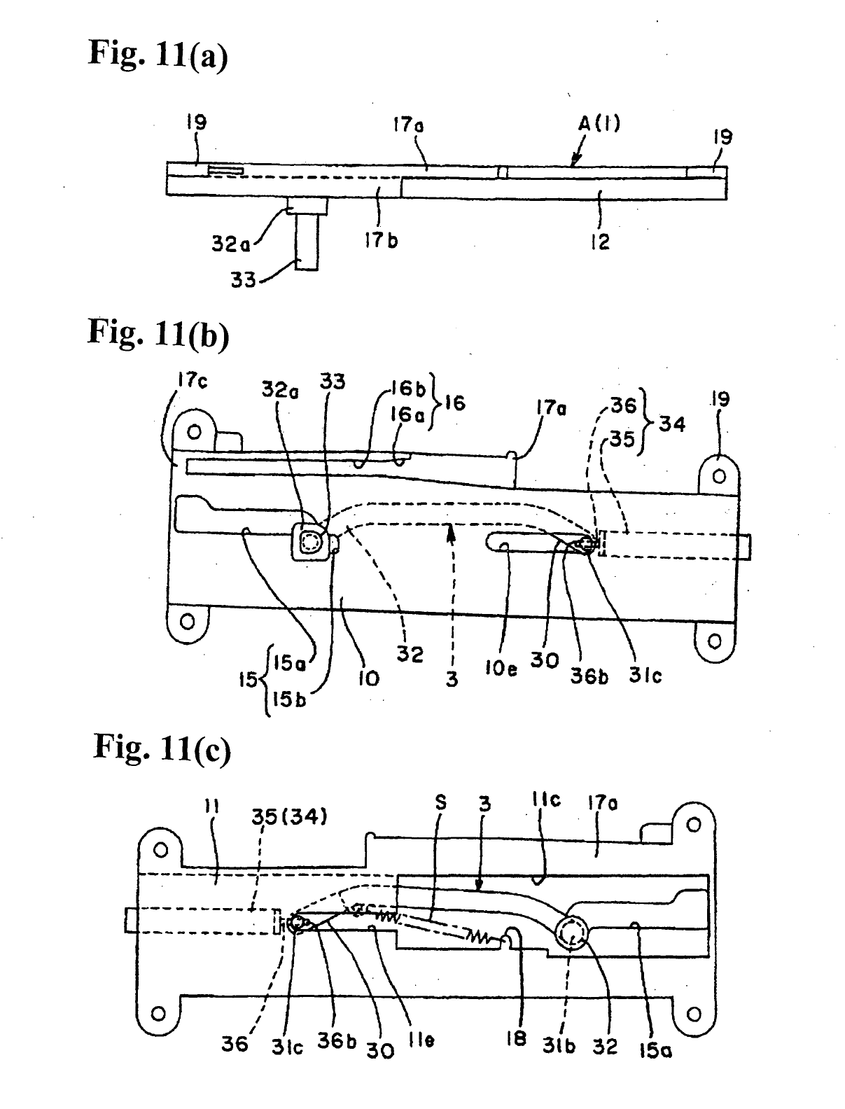

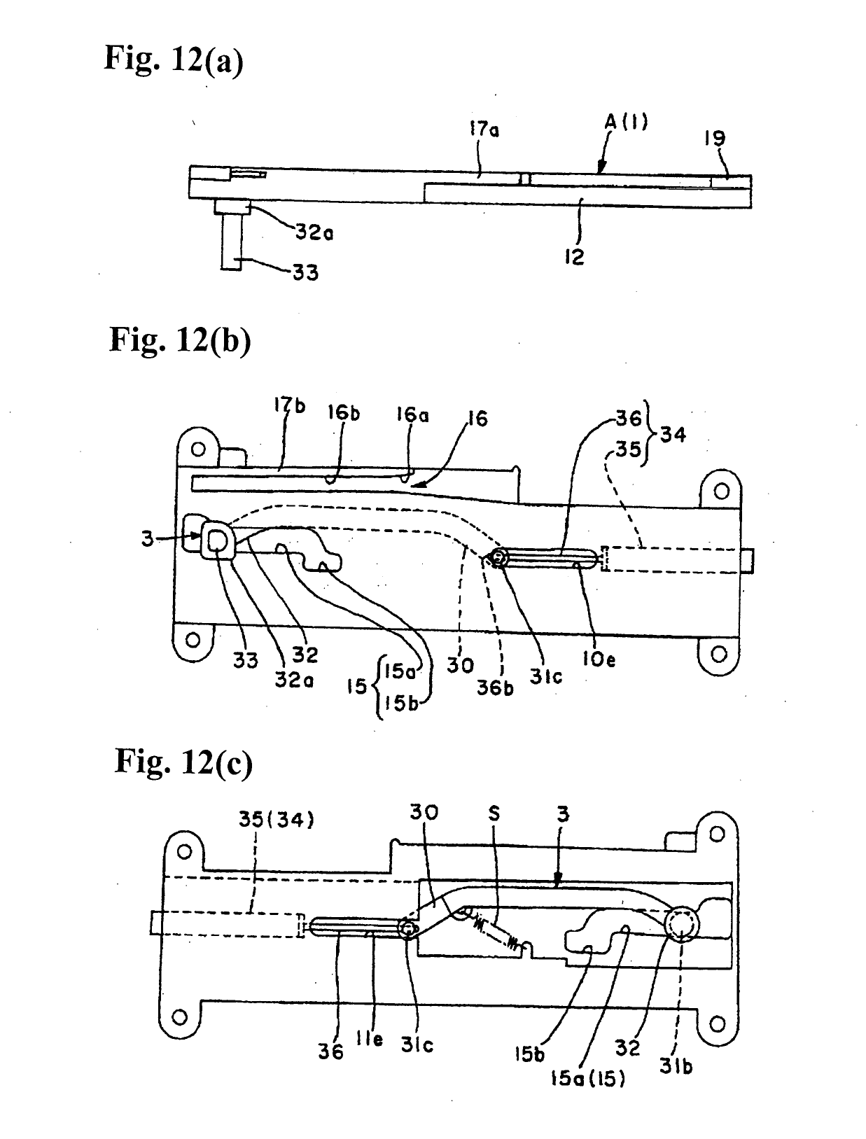

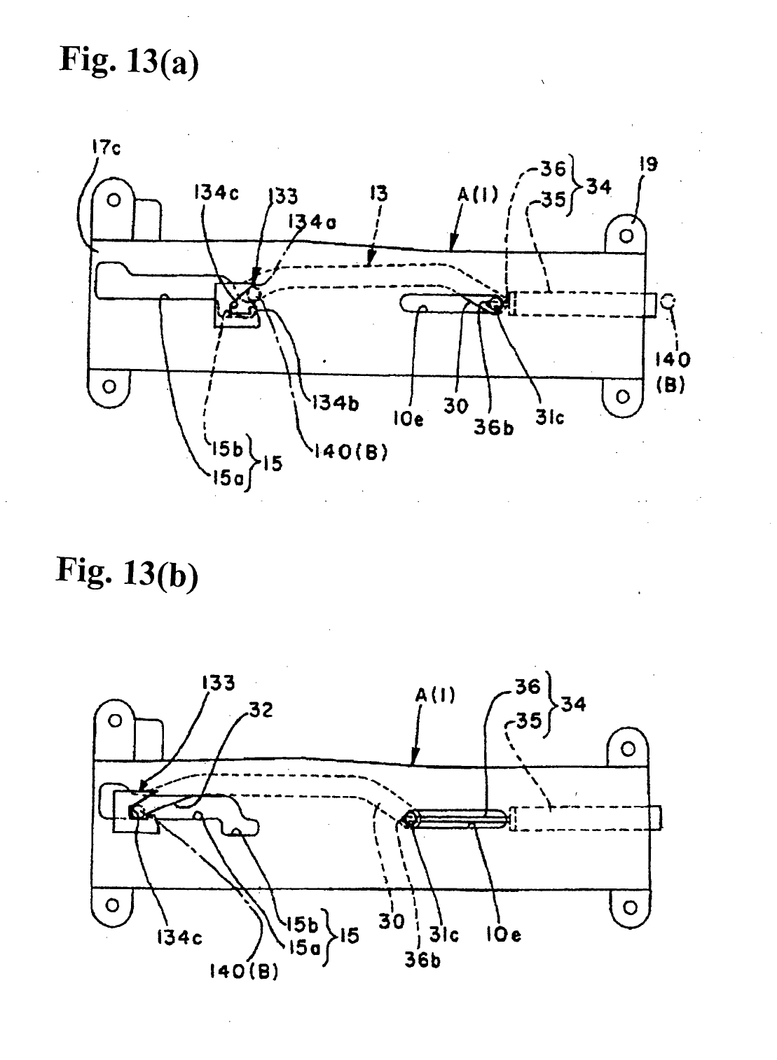

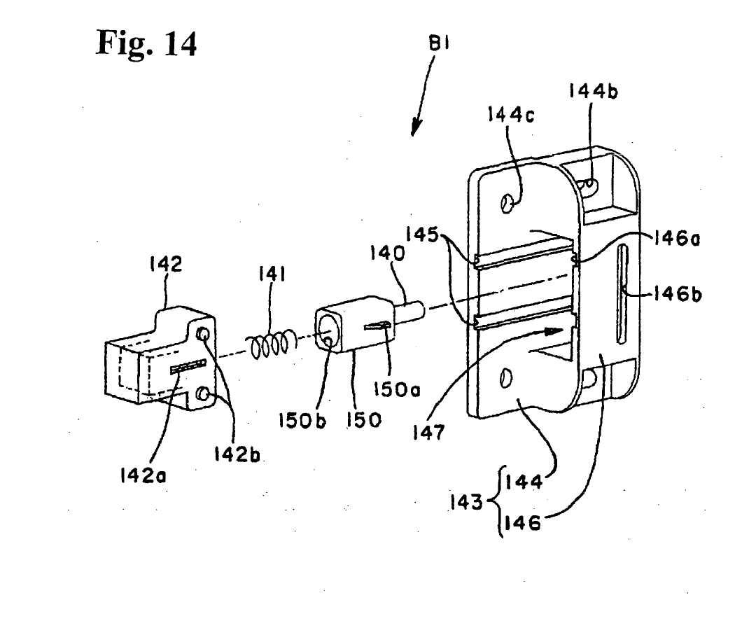

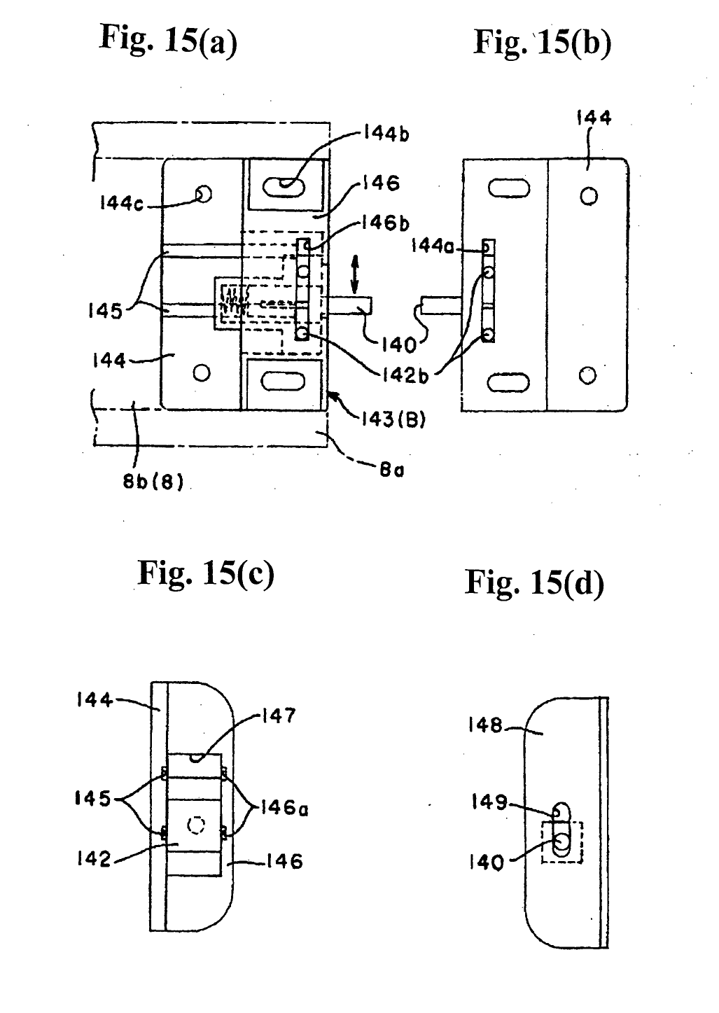

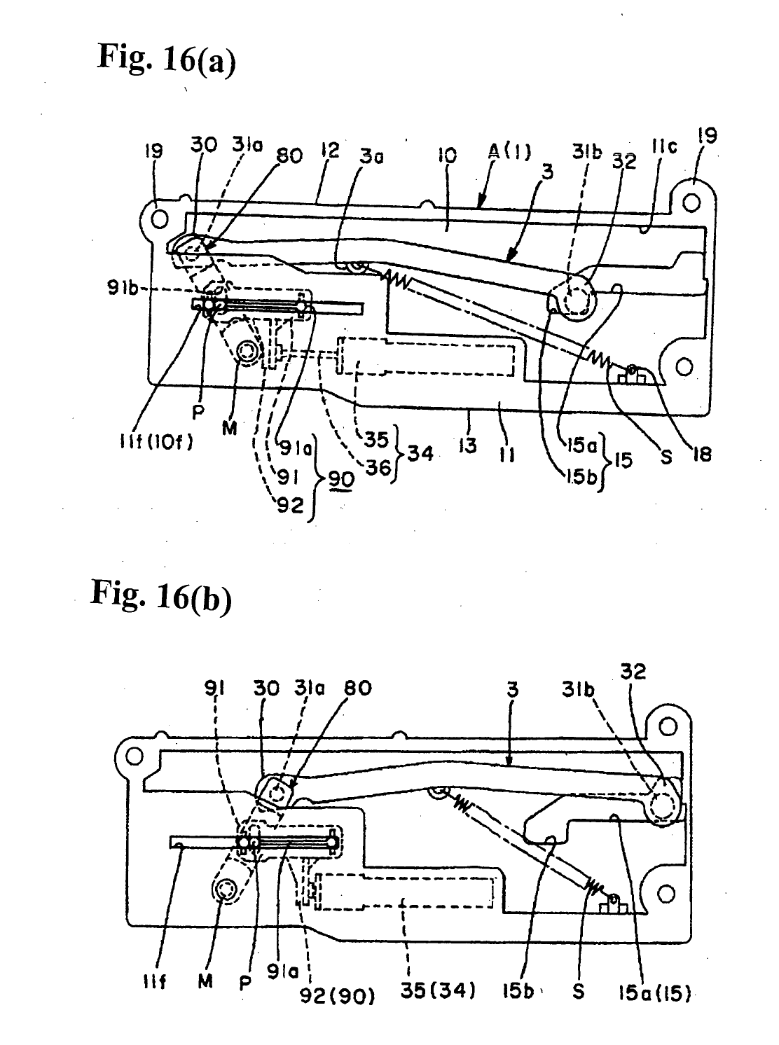

FIG. 1 shows a relationship between the retraction main body and the engaged means, FIGS. 2 to 4(c) show the structure and the operation characteristics of the retraction main body, FIGS. 5(a) to 5(e) show the structure and the operation characteristics of the engaged means, and FIGS. 6(a) to 9(b) show usage examples. Also, FIGS. 11(a), 11(b), and 12(a) to 12(c) show a first modified example of the second embodiment, FIGS. 13(a) to 15(d) show a second modified example of the second embodiment, and FIGS. 16(a), 16(b) show a third modified example of the second embodiment. Incidentally, in each figure, some portions are omitted or simplified for constructing the drawings. In the following explanation, the mechanism characteristics, the retraction main body, the engaged means, the usage examples, the operations, the first modified example, the second modified example, and the third modified example are described in detail in that order.

(Mechanism characteristics) For example, in the case that the usage is for moving the drawer body 8 into and out of the storage main body 9, the, retraction mechanism of the embodiment comprises the retraction main body A including an axial portion 33 as an engaging means which is attached to either the storage main body 9 or the drawer body 8 movably supported by the storage main body 9, and the coil spring S which is the urging means capable of accumulating the urging forces in a moving process of the drawer body 8; and the engaged means B including a bearing member 5 which is attached to the other body and engaged with/disengaged from the axial portion 33 at the predetermined moved position of the drawer body 8. In the state wherein the axial portion 33 and the bearing member 5 are engaged, due to the urging forces accumulated in the coil spring S, the retraction mechanism retracts the drawer body 8.

(Retraction main body) As shown in FIGS. 1 to 4(c), this retraction main body A comprises the approximately short-shaped case 1; the slider 2 slidably placed in the case 1; the arm 3 connected to the slider 2; the above-mentioned coil spring S; and the damping means 6 damping the movement of the slider 2 and the arm 3. Among these, the damping means 6 is constituted by the piston-type damper 34 and the rotary damper 37. The piston-type damper 34 has the structure of including the cylinder 35 and the piston rod 36 gently moving in and out of the cylinder, and that the piston rod 36 gently drives relative to the cylinder 35. The rotary damper 37 has the structure of including the case 38, the axis damped by the operating oil and the like inside the case, and the gear 39 mounted on the axis. However, the damping means 6 can be omitted, or only one of the dampers 34, 35 can be used, or conversely, the plural damper 37 can be used.

The case 1 is long and thin in the front and back direction, the inner space is approximately divided by the front face 10, the rear face 11, the upper and lower faces 12, 13, and one end face 14, and the other end face is open. The supporting groove 10a engaging and controlling the cylinder 35 of the piston-type damper, the damper attachment hole 10c, and the guide hole 15 fitted in the axial portion 33 provided in the arm 3, are provided in the front face 10. The damper 37 is attached to the attachment hole 10c in the state of engaging and fixing the case 38. The guide hole 15 comprises a first movement portion 15a horizontally extending just from the front of one end face 14, and a standby holding portion 15b bent downwardly from the end portion of the first movement portion. Guide grooves 10b, 11b guiding the slider 2 are oppositely provided on the front face 10 and the rear face 11. In addition to the guide groove 11b, the depressed storage portion 11a; the approximately short-formed opening portion 11c wherein the portion opposing the guide groove 15 is lacked; and the spring retainer portion 18 projecting from a lower inner face of the opening portion 11c, are provided in the rear face 11. The damper 34 is attached to the storage portion 11a in the state of engaging and fixing the cylinder 35.

The guide groove 16 with a C-shaped cross-section, which extends toward one end face 14 side from approximately the middle, is provided on the upper face 12. This guide groove 16 is divided by the longitudinal wall 17a provided on the upper face 12; the horizontal wall 17b projecting from the longitudinal wall 17a and opposing the upper face 12; and the standing wall 17c located in one end face 14 side and connecting each end portion of the horizontal wall 17b and the upper face 12. Also, the groove doorway portion 16a is formed wider, i.e., with a large top-to-bottom space, than the groove portion 16b which is located on the back side of the groove doorway portion 16a. Additionally, in the groove doorway portion 16a, the opposed portion of the upper face 12 and the horizontal wall 17b has the tapered face wherein the top-to-bottom space becomes narrower as the opposed portion of the upper face 12 and the horizontal wall 17b comes closer to the groove portion 16b. The reference numeral 19 represents the attachment portions.

The whole slider 2 has the slender plate shape which is approximately divided by both side faces 20, the upper and lower faces 21, 22, and the opposed end faces 23. The slider 2 includes the plural projected portions 24 respectively projecting from both side faces 20 and fitting in the guide grooves 10b, 11b on the case side; the through-hole 25 extending from one end face 23 toward the other middle side and penetrating the above-mentioned piston rod 36; the latching small opening 26 opened on both side faces 20 and intersecting the end of the through-hole 25; the rack 27 located on the upper face 21 and continuously provided from one end face 23 up to just before the other end face; and the approximately U-shaped supporting portion 28 provided between the rack 27 and the end face 23.

The arm 3 is formed in a loose arched shape as a whole, the other end portion 30 is pivotally supported at the supporting portion 28 on the slider side to be capable of freely turning, and one end portion 32 includes the axial portion 31b (see FIG. 1) fitted in the guide groove 15. Specifically, the other end portion 30 is formed in an approximately C-shape, which includes the connecting axis 31a (see FIG. 3(c)) provided between both piece portions of the C-shape and is connected to the supporting portion 28 on the slider side in the state wherein the connecting axis 31a is fitted in the inside of the U-shape. One end portion 32 forms the above-mentioned axial portion 31b projecting from the side face; the slightly large flange portion 32a provided in the end of the axial portion 31b so as not to escape from the guide hole 15; and the axial portion 33 projecting from the outside face of the flange portion 32a, on the same axial line. Also, just before the other end portion 30, the spring retainer portion 3a is projected downwardly.

The above-mentioned slider 2, the arm 3, and the coil spring S are mounted on the case 1 by the following procedure. At first, the slider 2 is entered into the case from the opening of the other end face, which opposes one end face 14 relative to the case 1. Also, the projected portions 24 on both sides are fitted in the guide grooves 10b, 11b so as to horizontally slide along the guide grooves. In this case, the piston rod 36 on the damper side placed inside the storage portion 11a is inserted into the through-hole 25 on the slider side, and the cap-shaped stopper 36a is placed in the end projecting from the small opening 26, so that the piston rod 36 is connected to the slider 2. Also, in the damper 37 placed in the attachment hole 10c, the gear 39 is engaged with the lack on the slider side. Consequently, the slider 2 is slid while being damped by the piston-type damper 34 and the rotary damper 37.

Also, as shown in FIG. 4(c), in the arm 3, the connecting axis 31a of the other end portion 30 is fitted in the supporting portion 28 on the slider side and mounted on the inside of the case 1 in the state wherein the axial portion 31b of one end portion 32 is penetrated into the guide groove 15. At that time, the flange portion 32a with a large diameter is inserted into the guide groove 15 by using the slightly large relief hole provided in the end portion of the first movement portion 15a, so that one end portion 32 is disposed in the case 1 in the retaining state. In this state, the axial portion 33 horizontally projects from the guide groove 15. Next, in the coil spring S, one end is latched to the retainer portion 18 on the case side, and the other end is latched to the retainer portion 3a on the arm side. Thereby, the retraction main body A is completed. The coil spring S here is disposed between the retainer portion 18 near a standby holding portion 15b side and the other end portion 30b side of the arm 3, and an urging direction is set so as to be lower than a line connecting one end portion 32 of the arm 3 and the other end portion 30.

(Engaged means) As shown in FIGS. 1 and 5(a) to 5(e), this engaged means B comprises the plate-shaped holding member 4 and the bearing member 5 supported by the holding member 4 to be capable of moving only for the predetermined top-to-bottom dimension. Among these, the holding member 4 includes the short-formed depressed portion 40, which is long from top to bottom and provided on the rear face side; the short-formed opening 41 whose two sides are penetrated except for the top-to-bottom portion and the right-to-left portion inside the depressed portion 40; the relief portion 42 whose upper one side portion inside the depressed portion 40 is devoid and which is communicated to the outside from the inside of the depressed portion 40; and the attachment holes 43 provided in the plural places.

The bearing member 5 includes the plate portion 50 corresponding to the depressed portion 40; an upper bearing portion 51 and a lower bearing portion 52 which are projected from the surface side of the plate portion 50 and disposed by projecting from the opening 41 to the front face side; and the claw member 45 mounted on the upper bearing portion 51 to be movable up and down. The plate portion 50 forms the projection 53, which fits in the above-mentioned guide groove 16 on the upper side of one side face. When the plate portion 50 is disposed to be movable in a top-to-bottom direction inside the depressed portion 40, the projection 53 is also moved up and down in the state of projecting from the relief portion 42 to the outside. The upper bearing portion 51 and the lower bearing portion 52 are retained through the claws 55 provided on both outside faces of the upper bearing portion 51 in the state of being projected from the opening 41 to the front face side of the plate portion 50 so as to be movable up and down. The lower bearing portion 52 is formed in the taper which is lowered as going down, and when the lower bearing portion 52 hits into the axial portion 33 of the above-mentioned latched state, due to the forward movement of the engaged means B, the lower bearing portion 52 allows the axial portion 33 to escape from the standby holding portion 15b to the first movement portion 15a by the above-mentioned taper function.

On the other hand, the upper bearing portion 51 is the hollow portion whose projecting end side is the lower portion and one portion 54 of the end face is open. Then, in the hollow portion, the guide ribs 56 guiding the claw member 45 are oppositely provided on both inside faces. Specifically, as shown in FIGS. 5(b), 5(d), in the claw member 45, the end is formed in the inclined surface, and also includes the longitudinal grooves 45a provided on both sides, and the elastic piece portion 46 projected from the upper side. Then, in the claw member 45, each longitudinal groove 45a is fitted in the corresponding guide rib 56, and the piece portion 46 is disposed in the state of abutting against the inner upper face of the above-mentioned hollow portion, so that usually, the claw member 45 is urged to the projecting state in FIGS. 5(b), 5(d) through the piece portion 46. If the claw member 45 receives the upward stress, the claw member 45 escapes in the going-down direction against the elastic force of the piece portion 46 once, and then, when the stress disappears, the claw member 45 becomes the projecting state again.

(Usage example) FIGS. 6(a), 6(b) (and the portion shown in the upper right in FIG. 1) are the example wherein the above retraction mechanism is applied to the retraction of the drawer body 8. In this placement, the retraction main body A is attached to the inside face of the storage main body 9, and also the engaged means B is attached to the back end face 8b of the drawer body 8. In this case, the retraction main body A is fixed by using the attachment portions 19, the screws, and the like. The engaged means B is fixed by using the attachment holes 43, the screws, and the like. However, at that time, the projection 53 is positioned so as to project from the drawer body side face 8a in response to the guide groove 16 of the retraction main body A. Incidentally, as the other placement, the retraction main body A can be attached to the drawer body 8 side, and corresponding to that, the engaged means B can be attached to the storage main body 9 side. Also, the retraction main body A and the engaged means B can retract the movable body by using two pairs of movable bodies. However, in such a case, if the movable body is the drawer body 8, one side has a symmetrical shape relative to the above-mentioned embodiment.

(Operations) Operations of the above retraction mechanism will be explained in detail with reference to FIGS. 3(a) to 3(c), 4(a) to 4(c), and 7(a) to 9(b). Incidentally, in FIGS. 7(a) to 9(b), main operations are shown on the assumption of the usage example of FIGS. 6(a), 6(b), and FIGS. 7(a) to 9(b) are simplified or schematized in order to demonstrate the relationship of each member.

(1) At first, the operational characteristics of the retraction main body A are to be capable of being switched between the urging-force accumulation state wherein the coil spring S accumulates the urging forces as shown in FIG. 3(c), and the urging-force release state wherein the coil spring S releases the urging forces as shown in FIG. 4(c), or the retracted state. In the urging-force accumulation state, the coil spring S accumulates the urging forces up to the maximum through the sliding of the arm 3. In the arm 3, the axial portion 31b is latched to the standby holding portion 15b. In the damper 34, the piston rod 36 is largely extracted from the cylinder 35. Then, from the urging-force accumulation state, when the latching of the axial portion 31b is released from the standby holding portion 15b and the axial portion 31b is allowed to escape to the first movement portion 15a, the axial portion 33, the arm 3, and the slider 2 are integrally slid along the first movement portion 15a by the urging force of the coil spring S. This latching release is carried out with the engagement of the engaged means B relative to the axial portion as mentioned hereinafter. When the latching is released, the engaged means B is interlocked with the arm 3 and slid by maintaining the engagement state between the axial portion 33 and the bearing member 5, i.e., the engaged means B is automatically retracted while being damped by the above-mentioned dampers 34, 37. In this retraction mechanism, in the urging-force release state or a retraction completion state, the coil spring S releases the urging force through the sliding of the arm 3, or minimizes the urging force. The arm 3 disposes the axial portion 31b in an appropriate place of the first movement portion 15a. The damper 34 is in the state wherein the piston rod 36 is sunk in the cylinder 35 the most.

(2) FIGS. 7(a), 7(b) show the operation which corrects the mutual engagement positional relationship by the guide means 7 at a previous stage that the engaged means B engages the retraction main body A. As the usage example of FIGS. 6(a), 6(b), for example, this is to solve the problem by the guide means 7, wherein the relative position between the claw member 45 disposed in the upper bearing portion 51 constituting the bearing member 5, the lower bearing portion 52, and the axial portion 33 of the retraction main body A, changes due to the change of the load capacity or the storage load in the drawer body 8, so that the claw member 45, the lower bearing portion 52, and the axial portion 33 cannot be normally engaged with one another. Specifically, in this guide means 7, as shown in FIG. 7(b), when the engaged means B is moved closer to the retraction main body A, (A) the projection 53 on a bearing portion side is slid in the state of being fitted in the guide groove 16 on the case side, so that the bearing member 5 (the lower bearing portion 52 and the claw member 45) and the axial portion 33 are accurately positioned; (B) the projection 53 is received at the wide groove doorway portion 16a among the guide groove 16, and moved while being centered by the narrow groove portion 16b, so that even if the groove width direction, i.e., the top-to-bottom position between the bearing member 5 (the lower bearing portion 52 and the claw member 45) and the axial portion 33 has changed, the position can be efficiently modified; and (C) the bearing member 5 (the lower bearing portion 52 and the claw member 45) is supported relative to the holding member 4 to be movable only for a predetermined dimension, so that the bearing member 5 changes the position within the allowed moving range and is adjusted in the most appropriate position relative to the axial portion 33. Due to those operations, the change of the above-mentioned relative position is efficiently and reliably absorbed, so that the improper operation is eliminated.

(3) FIGS. 8(a), 8(b) show a retraction operation when the engaged means B is engaged with the retraction main body A, and retracted by the urging force. Specifically, in this retraction mechanism, as shown in FIG. 8(a), when the engaged means B is moved closer to the retraction main body A, at first, the claw member 45 on a bearing member side moves upwardly against the urging of the above-mentioned piece portion 46 and passes through the axial portion 33, and at the same time, the axial portion 33 is pushed upwardly or in an obliquely upward direction by the taper shape of the lower bearing portion 52, so that the engaged means B is allowed to escape from the standby holding portion 15b to the first movement portion 15a so that the latching is released. In this latching release, the arm 3 turns as a supporting point of the axial portion 31a on the other end portion side, and displaces one end portion 32 in an upper direction. Thereby, in the engaged means B, as shown in FIG. 8(b), by maintaining the engagement between the bearing member 5 (the lower bearing portion 52 and the claw member 45) and the axial portion 33, the arm 3 and the slider 2 are slid by the urging force of the coil spring S, and the movable body such as the drawer body and the like is retracted by being interlocked with the sliding. As the usage example of the above-mentioned FIGS. 6(a), 6(b), due to the urging forces accumulated in the coil spring S from the middle wherein the drawer body 8 is pushed in, the drawer body 8 is automatically retracted (while being damped by the damping means 6) up to the final pushed-in position, and thereby, rebound when the drawer body 8 is swiftly pushed in, can be prevented, and also the occurrence of the incomplete pushed-in state of the drawer body 8 can be prevented.

(4) FIGS. 9(a), 9(b) show the operation at the time that the movable body such as the drawer body 8 and the like is moved from the retracted state in FIG. 8(b) to the withdrawal direction again, and the above-mentioned engagement is released. Specifically, in this retraction mechanism, as shown in FIG. 9(a), in the process that the engaged means B is moved in the direction away from the retraction main body A again, at first, in the state wherein the axial portion 33 is engaged with the bearing member 5 (the lower bearing portion 52 and the claw member 45), when the engaged means B comes to the top of the standby holding portion 15b which is one step lower from the first movement portion 15a, the engaged means B is pushed by the claw member 45, entered into the standby holding portion 15b, and latched. As for the switchover to this latched state, the axial portion 31b is reliably latched to the standby holding portion 15b by the following. The arm 3 turns as the supporting point of the axial portion 31a on the other end portion side, and displaces the axial portion 31b on one end portion side in a downward direction which is the standby holding portion 15b side; the urging direction of the coil spring S is the downward direction which is the same as the standby holding portion 15b compared to the line connecting both end portions of the arm 3; the arm 3 is pressed so as to displace the axial portion 31b to the standby holding portion 15b side by one portion of the urging force thereof; and the like. As a result, in this retraction mechanism, compared to Patent Document 2, the urging-force accumulation state can be always maintained stably, so that the occurrence of the improper operation can be prevented. Additionally, the depth of the groove of the standby holding portion 15b can be made shallow, so that the space in the height direction can be controlled, and it is easier to be downsized. Incidentally, in this retraction mechanism, in the state wherein the axial portion 33 is engaged with the lower bearing portion 52 and the claw member 45, when the engaged means B is moved up to the place of FIG. 9(a) from FIG. 8(b) by a withdrawal operation such as the drawer body 8 and the like, the axial portion 33, i.e., the arm 3 and the slider 2 are also interlocked and moved in the same direction, so that the urging forces are accumulated in the coil spring S. Obviously, this urging-force accumulation continues up to the time that the bearing member 5 (the lower bearing portion 52 and the claw member 45) of the engaged means B is disengaged from the axial portion 33. Specifically, after the axial portion 31b is latched to the standby holding portion 15a, as shown in FIG. 9(b), the lower bearing portion 52 and the claw member 45 constituting the bearing portion disengage the engagement with the axial portion 33, and the engaged means B is separately moved in an operation direction.

(First modified example of the second embodiment) The first modified example of the second embodiment of FIGS. 11(a) to 11(c), and 12(a) to 12(c) is an example wherein the above-mentioned embodiment is simplified. In this explanation, the same symbols are assigned to the same members and the operationally same portions with those of the above-mentioned embodiment, and only changed structures will be described by omitting duplicated descriptions as much as possible.

In this withdrawal mechanism, among structure members of the above-mentioned retraction main body A, the slider 2 and the rotary damper 6 are omitted. Specifically, this retraction main body A comprises the case 1; the arm 3 including the axial portion 33; the coil spring S as the urging means; and the piston-type damper 34 damping the movement of the arm 3.

The case 1 is long and thin in the front and back direction, the inner space is approximately divided by the front face 10, the rear face 11, the upper and lower faces 12, 13, and one end face 14, and the other end face is open. Grooves as second movement portions or long holes 10e, 11e are oppositely provided on the front face 10 and the rear face 11. Each long hole 10e, 11e is formed in a linear fashion with the length approximately the same as that of the first movement portion 15a of the guide groove 15, and extends in a moving direction of the arm 3. The other end portion 30 of the arm 3 is formed in an approximately C-shape, and includes the above-mentioned connecting axis 31a provided between both piece portions of the C-shape, and also axial portions 31c projected from outside faces of both piece portions of the C-shape. Then, the other end portion 30 of the arm is fitted in the long holes 10e, 11e wherein the axial portions 31c on both sides correspond, and in the fitted state, the other end portion 30 of the arm allows the arm 3 to turn and move.

Also, in the case 1, the cylinder 35 of the piston-type damper 34 can be placed between the long holes 10e, 11e, and the other end face of the case. Then, the damper 34 is placed in the state wherein the cylinder 35 projects the back end to the outside of the case relative to the case 1. Also, the piston rod 36 is inserted into a through-hole which is not shown in the figures and provided in the above-mentioned connecting axis 31a, and a cap-shaped stopper 36b is placed in the end projecting from the through-hole, so that the damper 34 is connected to the other end portion 30 of the arm. Even in the above retraction mechanism, the retraction mechanism operates as in the same fashion with the above-mentioned embodiment, and also, simplified due to the portion wherein the slider 2 is omitted.

(Second modified example of the second embodiment) The second modified example of the second embodiment of FIGS. 13(a) to 15(d) is an example wherein the above-mentioned engaging means are changed from the axial portion to a bearing portion structure, and conversely, the engaged means B is changed from the bearing portion to an axial portion structure. Also, in this modified example, the above-mentioned guide means is omitted. In this explanation, the same symbols are assigned to the same members and the operationally same portions with those of the above-mentioned embodiment and the first modified example, and only changed structures will be described in detail.

This withdrawal mechanism has a structure that a bearing portion 133 is used in place of the axial portion 33 on the above-mentioned arm one end side, and that an engaged portion B includes an axial portion 140 engaged with/disengaged from the bearing portion 133. Specifically, the bearing portion 133 is provided in the state of being connected to the axial portion 31b on the above-mentioned arm one end portion side or a flange portion 32, and has an approximately C-shape which can engage and disengage the axial portion 140. The shape of the bearing portion 133 is formed in a taper wherein the inner face of a C-shaped upper piece portion 134a becomes higher as going to the end. Also, the bearing portion 133 includes an upward retainer projection 134b provided in the end of a C-shaped lower piece portion.

On the other hand, the engaged portion B includes the axial portion 140, a holding member 142, a base 143, and the like. The axial portion 140 is supported relative to the holding member 142 against an urging force of an urging spring 141 so as to be capable of displacing a projection dimension, and also supported relative to the base 143 so as to be capable of moving the holding member 142 only for a predetermined dimension. Here, the axial portion 140 is made of steel, and projected from a supporting portion 150. The supporting portion 150 includes latching claws 150a provided on both side faces, and a hole portion 150b wherein the side opposite to the side projecting the axial portion 140 is formed in a depressed shape. The holding member 142 has an approximately T-shape, and forms a holding hole disposing the supporting portion 150 to be freely slidable. Also, the holding member 142 includes guide holes 142a respectively provided on both side faces, and projected portions 142b. The guide holes 142a on both sides extend in a front and back direction, and when the supporting portion 150 is inserted into the holding hole of the holding member 142 in the state wherein the urging spring 141 is disposed in the hole portion 150b, the guide holes 142a fit in the latching claws 150a, so that the supporting portion 150 is retained to be capable of freely sliding. The projected portions 142b are provided on upper and lower parts sandwiching the guide holes 142a at the front side.

The base 143 integrally includes a plate portion 144 and an overhanging portion 146 provided on one side of the plate portion 144. A holding space 147 is formed between the plate portion 144 and the overhanging portion 146 and divides them, and the back side of the holding space 147 is closed by a side wall 148. In the plate portion 144 and the overhanging portion 146, control grooves 144a, 146b extending up and down are oppositely provided, and also pairs of depressed portions 145 and depressed portions 146a extending from right to left are oppositely provided. The depressed portions 145 and the depressed portions 146a lead into the control grooves 144a, 146b, and enable to guide up to the control grooves 144a, 146b in the state of fitting each projected portion 142b. A long hole 149 is provided in the side wall 148. As for the above base 143, in the state wherein the axial portion 140 is mounted on the holding member 142, when each projected portion 142b is fitted in the depressed portions 145 and the depressed portions 146a, and moved to the inside of the holding space 147, the axial portion 140 is projected from the long hole 149 to the outside, and each projected portion 142b is fitted in the control grooves 144a, 146b from the depressed portions 145 and the depressed portions 146a. Thereby, the holding member 142 supports the axial portion 140 to be capable of varying the projecting dimension thereof against the urging force. Also, the holding member 142 is supported relative to the base 143 in the state wherein each projected portion 142b is slidably fitted in the control grooves 144a, 146b, so that the axial portion 140 enables to move up and down relative to the long hole 149 only for a distance responding to a hole dimension. The reference numerals and alphabets 144b, 144c represent attachment holes additionally provided in the base 143.

In the above retraction mechanism, FIG. 13(a) corresponds to FIG. 8(a), and FIG. 13(b) corresponds to FIG. 8(b). Specifically, FIG. 13(a) shows the state just before the axial portion 140 of the engaged means B is engaged with the bearing portion 133 of the retraction main body A. In this retraction mechanism, when the axial portion 140 of the engaged means B is approached to the bearing portion 133, the axial portion 140 hits against the inside tapered face of the upper piece portion 134a on the bearing portion side. Then, the axial portion 140 receives an upward stress from the tapered face of the upper piece portion 134a, and moves upwardly only for a predetermined dimension relative to the long hole 149 through the holding member 142. Thereby, as shown in FIG. 13(b), the axial portion 140 is engaged inside the C-shape of the bearing portion 133. At the same time, the axial portion 33 (not shown in the figure) on the above-mentioned arm one end side is allowed to escape from the standby holding portion 15b to the first movement portion 15a, and the latching is released. Thereby, as shown in FIG. 13(b), the engaged means B maintains the engagement between the bearing portion 133 and the axial portion 140, the arm 3 is slid by the urging force of the coil spring S, and the movable body such as the drawer body and the like is interlocked with the sliding thereof and retracted. Also, in the process that the movable body such as the drawer body and the like is moved from the retracted state in FIG. 13(b) to the withdrawal direction again, in the state wherein the axial portion 140 is engaged with the bearing portion 133, when the axial portion 140 comes to the top of the standby holding portion 15b which is one step lower from the first movement portion 15a, the axial portion 140 is moved downwardly relative to the long hole 149 through the holding member 42 only for the predetermined dimension, so that the engagement is released.

(Third modified example of the second embodiment) The third modified example of the second embodiment of FIGS. 16(a), 16(b) is an example wherein the structure of the second movement portion and the relationship with the piston-type damper are changed. In this explanation, the same symbols are assigned to the same members and the operationally same portions with those of the above-mentioned embodiment, the first modified example, and the second modified example, and only changed structures will be described in detail.

In this withdrawal mechanism, as for the above-mentioned retraction main body A, the following is changed. The second movement portion is structured by a link member 80 rotatably attached to the inside of the case 1, and the piston-type damper 34, which is the damping means, is structured to damp the arm 3 through a connecting member 90 and the link member 80.

Specifically, in the case 1, the inner space is approximately divided by the front face 10, the rear face 11, the upper and lower faces 12, 13, and both end faces. In the front face 10 and the rear face 11, guide portions 10f, 11f are oppositely provided. The guide portions 10f, 11f are provided on the side, which departs from the guide groove 15 (the first movement portion 15a and the standby holding portion 15b), are straight grooves which are the same as the first movement portion 15a and extend in the moving direction of the arm 3. Inside the case 1, the cylinder 35 of the piston-type damper 34 is placed on the lower side and approximately in the middle portion of the right and left. Also, the link member 80 and the connecting member 90 are provided corresponding to the piston rod 36 of the damper 34. Among these, the whole link member 80 has a slender plate shape, and includes a thin wall portion provided in the middle portion, a pin hole provided in the thin wall portion, and an axial hole provided in the lower end portion. In the state wherein the lower end portion is rotatably attached through an axis M penetrated into the above-mentioned axis, the upper end portion is fitted and connected relative to the above-mentioned arm other end portion 30 through the connecting axis 31a and the like. On the other hand, the connecting member 90 is formed in an approximately T-shape as viewed from a side surface, and comprises a horizontal piece portion 91 and a vertical piece portion 92. The horizontal piece portion 91 includes projections 91a provided on both side faces; an approximately C-shaped fitting portion provided in the end; and longitudinal holes 91b provided in the fitting portion. Then, for example, the projections 91a on both sides are slidably fitted in the above-mentioned guide portions 10f, 11f, and also the above connecting member 90 is mounted on the inside of the case 1 so as to fit the middle thin wall portion of the link member 80 in the inside of the C-shape of the above-mentioned end fitting portion. After that, a pin P is disposed in one longitudinal hole 91b, the pin hole on a thin wall portion side of the link member 80, and the other longitudinal hole 91b, so that the link member 80 and the connecting member 90 are operated and connected.

In the above retraction mechanism, FIG. 16(a) corresponds to FIG. 3(c), and FIG. 16(b) corresponds to FIG. 4(b). Specifically, as operational characteristics, the urging-force accumulation state wherein the coil spring S shown in FIG. 16(a) accumulates the urging forces, and the urging-force release state wherein the coil spring S releases the urging forces as shown in FIG. 16(b), or the retracted, can be switched over. In the urging-force accumulation state, the coil spring S accumulates the urging forces up to the maximum through the sliding of the arm 3. In the arm 3, the axial portion 31b is latched to the standby holding portion 15b. In the damper 34, the piston rod 36 is extracted from the cylinder 35, and abutted against or connected to the vertical piece portion 92 of the connecting member 90. Then, from the urging-force accumulation state, when the latching of the axial portion 31b is released from the standby holding portion 15b and the axial portion 31b is allowed to escape to the first movement portion 15a, the arm 3 is slid along the first movement portion 15a by the urging force of the coil spring S. In this sliding of the arm 3, the arm other end portion 30 is endured with a rotating operation of the link member 80. Specifically, in this retraction mechanism, when the latching of the axial portion 31b is released from the standby holding portion 15b, the link member 80 is rotated in clockwise direction or to a guide groove 15 side as a supporting point of the axis M. Then, while being pressed by the rotation of the link member 80, and while being damped by the damper 34 with guiding operations of the projections 91a and the guide portions 10f, 11f, the connecting member 90 is slid up to the position in FIG. 16(b) from FIG. 16(a). In the urging-force release state or the retraction completion state in FIG. 16(b), the damper 34 is in the state wherein the piston rod 36 is sunk in the cylinder 35 the most. As described above, as the structure of damping the sliding of the arm 3 by the damper 34, when the damper 34 is operated and connected through the link member 80 and the connecting member 90, for example, a stroke of the piston rod 36 can be reduced to approximately half, so that damping efficiency can be improved.

Incidentally, in the retraction mechanism of the present invention, details can be further modified or developed by reference to the first and second, embodiments and each modified example provided that they substantially comprise the structure specified in independent claims. As an example thereof, the urging means is not limited to the coil spring S, and may be an elastic member such as a leaf spring, rubber, and the like.

Incidentally, the specifications, claims, drawings, and abstracts of Japanese Patent Applications No. 2008-008001 filed on Jan. 17, 2008 and No. 2008-044427 filed on Feb. 26, 2008 are cited in their entirety herein and are incorporated as a disclosure of the specification of the present invention.

1. A retraction mechanism, comprising:
a striker provided in either a fixed body or a movable body which is movably supported by the fixed body;
a catcher provided in the other body, and engaging with and disengaging from said striker at a predetermined moved position of said movable body; and
urging means enabling to accumulate urging forces in a moving process of said movable body,
wherein said movable body is retracted by the urging forces accumulated in said urging means in a state where said striker and said catcher are engaged,
wherein guide means controlling a relative position between said striker and said catcher is included, and
when said striker and said catcher change said relative position, the change thereof is absorbed by said guide means so that the engagement is made.

2. A retraction mechanism according to claim 1, wherein said striker is disposed in a case with said urging means, and said catcher is supported by a holding member.

3. A retraction mechanism according to claim 2, wherein said catcher is supported relative to said holding member to be capable of moving only for a predetermined dimension.

4. A retraction mechanism according to claim 2, wherein said striker is attached to said fixed body through said case to be capable of moving only for a predetermined dimension.

5. A retraction mechanism according to claim 2, wherein said guide means includes a guide groove provided in a case side and forming a groove doorway portion wider than the other groove portions, and a projection provided in a catcher side and sliding in said guide groove.

6. A retraction mechanism, comprising:
a retraction main body including engaging means attached to either a fixed body or a movable body which is movably disposed at the fixed body;
engaged means attached to the other body and engaged with and disengaged from said engaging means at a predetermined moved position of said movable body,
wherein said movable body enables to move by an urging force in an engagement state between said engaging means and the engaged means,
said retraction main body includes a case, an arm movably stored in said case and having said engaging means, and urging means urging said arm in a retracting direction;
said case includes a first movement portion for moving a relative position of the arm in a state wherein one end side of said arm is fitted, a guide groove flexed to a lower side from the first movement portion and comprising a standby holding portion for enabling to hold the urging force of said urging means, and a second movement portion allowing a turning and moving of the arm in a state wherein other end side of said arm is fitted; and
one end side of said arm is released from the latching of said standby holding portion due to the engagement between said engaging means and engaged means, and the arm is moved along said first movement portion by the urging force of said urging means, and
when the arm is moved in an opposite direction, the urging forces are accumulated in said urging means by maintaining the engagement between said engaging means and engaged means, and one end side reaches said standby holding portion from said first movement portion.

7. A retraction mechanism according to claim 6, wherein said engaging means and engaged means comprise an axial portion and a bearing portion which are engaged with and disengaged from each other, or a bearing portion and an axial portion which are engaged with and disengaged from each other.

8. A retraction mechanism according to claim 6, wherein said urging means is set such that an urging direction is located below a line connecting one end of said arm and the other end.

9. A retraction mechanism according to claim 6, wherein said second movement portion is a slider slidably provided relative to said case.

10. A retraction mechanism according to claim 6, wherein said second movement portion is a groove or a long hole provided in said case and extending in a moving direction of said arm.

11. A retraction mechanism according to claim 6, wherein said second movement portion is a link member rotatably attached as a supporting point of an attachment portion to said case.

12. A retraction mechanism according to claim 6, wherein damping means is provided in said case and damps a movement speed of said arm.

13. A retraction mechanism, wherein in claims 11, said damping means is a piston-type damper including a cylinder and a rod, and the damper is abutted against or connected to said rod, and also damps through a connecting member connected between both ends of said link member.
